(19) United States
(12) Patent Application Publication
(10) Pub. No.: US 2024/0029182 A1
(43) Pub. Date: Jan. 25, 2024

(54) COMPUTER-IMPLEMENTED AND INTERACTIVE REAL ESTATE CONTRACT GENERATION AND EDITING PROCESS

(71) Applicant: Anthony Makins, Coconut Creek, FL (US)

(72) Inventor: Anthony Makins, Coconut Creek, FL (US)

(21) Appl. No.: 18/372,494

(22) Filed: Sep. 25, 2023

Related U.S. Application Data
(63) Continuation-in-part of application No. 17/526,150, filed on Nov. 15, 2021, now Pat. No. 11,769,219.

(51) Int. Cl. G06Q 50/16; G06Q 10/10

(52) U.S. Cl. CPC G06Q 50/16; G06Q 10/10

(57) ABSTRACT

A computer-implemented and interactive real estate contract generation and editing process that allows a user to couple with a remote serve and initiate a network-based remote easy contract formation session that displays a plurality of independent and sequentially viewable windows on the GUI of a user's device and that includes contract formation text for a user to insert contract formation data therein. Beneficially, the process includes associating the contract formation data using with preformed paragraphs in a digital contractual document using an array structure and/or using AI to read and review the contract formation data before inserting into the digital document, thereby ensure the contract is formed accurately and efficiently.

### FIELD OF THE INVENTION

The present invention relates generally to real estate contracts, and, more particularly, relates to a computer-implemented and interactive real estate contract generation and editing process.

### BACKGROUND OF THE INVENTION

Real estate purchase agreements are generally drafted by a few select categories of qualified individuals, namely, real estate agents or attorneys. As a result, parties looking to buy and/or sell real estate are typically forced to solicit the assistance of these qualified individuals and wait for said individuals to draft, edit, revise, and finalize the subject purchase agreement before being able to proceed with the additional steps involved in a purchase and sale transaction, e.g., appraisal, financing, closing, etc. In many cases, this dependence on such a select group of individuals results in the loss of valuable time that may jeopardize the success of purchase and sale transactions, particularly where such transactions are time-sensitive, subject to conditions, or occurring in a market with more demand than supply.

There are some known computer-implemented methods and systems for generating contracts. These known methods and systems fail to provide adequate information and direction to putative buyers and/or seller. Additionally, these known methods and systems are also typically confusing to navigate through.

Therefore, a need exists to overcome the problems with the prior art as discussed above.

### SUMMARY OF THE INVENTION

The invention provides a computer-implemented and interactive real estate contract generation and editing process that overcomes the hereinafore-mentioned disadvantages of the heretofore-known devices and methods of this general type and that beneficially allows any user to easily, quickly, and conveniently draft purchase and sale transactions from the comfort of an electronic device owned or utilized by the user.

With the foregoing and other objects in view, there is provided, in accordance with the invention, a computer-implemented and interactive real estate contract generation and editing process comprising the steps of providing a first electronic computing device of a first user and a computer server; communicatively coupling the first electronic computing device of the first user to the computer server over a wireless communication network and generating a digital graphical user interface (GUI) on an electronic display of the first computing device with a plurality of digital data input fields operably configured to receive alpha-numeric text; initiating a network-based remote easy contract formation session that includes selecting a plurality of GUI icons on the electronic display of the first computing device and inputting contract formation data into each of the plurality of digital data input fields; and generating a digital document in the network-based remote easy contract formation session with a plurality of independent preformed paragraphs each having at least one fillable contract data field disposed therein and assigned and filled in with, using an array data structure, to one of the plurality of digital data input fields to create a finalized digital document without any fillable contract data field therein and that is downloadable to the electronic display of the first computing device.

In accordance with another feature, the first electronic computing device of the first user is geographically located at a different physical building location than the computer server.

In accordance with another feature, an embodiment of the present invention includes the step of communicatively coupling the first electronic computing device of the first user to the computer server over the wireless communication network and registering into a user account resident on the computer server before generating the digital GUI on the electronic display of the first computing device.

In accordance with a further feature of the present invention, the computer-implemented and interactive real estate contract generation and editing process further comprises the step of generating the finalized digital document without fillable contract data field therein and that is transferrable from the electronic display of the first computing device to a second computing device of a second user over the wireless communication network.

In accordance with a further feature of the present invention, the computer-implemented and interactive real estate contract generation and editing process also includes a digital informational icon disposed proximal to each of the plurality of digital data input fields and having informational text included therein; and displaying the informational text on the electronic display of the first computing device upon selectively modulating the digital informational icon.

In accordance with the present invention, an embodiment of the present invention includes a plurality of independent and sequentially viewable windows within the network-based remote easy contract formation session that collectively form part of selecting the plurality of GUI icons on the electronic display of the first computing device and the inputting contract formation data into each of the plurality of digital data input fields, the plurality of independent and sequentially viewable windows generating before generation of the digital document in the network-based remote easy contract formation session with the plurality of independent preformed paragraphs.

In accordance with another feature, an embodiment of the present invention also includes the step of initiating, in lieu of the network-based remote easy contract formation session, a network-based remote do-it-yourself contract formation session that includes generating a digital document with a plurality of GUI icons on the electronic display of the first computing device, with a plurality of independent preformed paragraphs each having at least one digital data input field therein, and filling in the at least one digital data input field to create a finalized digital document without any fillable contract data field therein and that is downloadable to the electronic display of the first computing device.

In accordance with yet another feature, an embodiment of the present invention includes a plurality of independent and sequentially viewable windows within the network-based remote do-it-yourself contract formation session that collectively form part of the digital document with the plurality of GUI icons on the electronic display of the first computing device.

In accordance with a further feature of the present invention, the computer-implemented and interactive real estate contract generation and editing process also includes selectively choosing on the first electronic computing device of a first user one of either the easy contract formation session or the do-it-yourself contract formation session.

The present invention also provides a computer-implemented and interactive real estate contract generation and editing process comprising the steps of providing a first electronic computing device of a first user and a computer server; communicatively coupling the first electronic computing device of the first user to the computer server over a wireless communication network and generating a digital graphical user interface (GUI) on an electronic display of the first computing device with a plurality of digital data input fields operably configured to receive alpha-numeric text; initiating a network-based remote easy contract formation session that includes inputting contract formation data into each of the plurality of digital data input fields in a plurality of independent and sequentially viewable windows that collectively form part of selecting the plurality of GUI icons on the electronic display of the first computing device and the inputting contract formation data into each of the plurality of digital data input fields, the plurality of independent and sequentially viewable windows generating before generation of the digital document in the network-based remote easy contract formation session with the plurality of independent preformed paragraphs; and generating a digital document in the network-based remote easy contract formation session with a plurality of independent preformed paragraphs each having at least one fillable contract data input field disposed therein and assigned and filled in with one of the plurality of contract formation data to create a finalized digital document.

In accordance with the present invention, a computer-implemented and interactive real estate contract generation and editing process comprising the steps of providing a first electronic computing device of a first user and a computer server; communicatively coupling the first electronic computing device of the first user to the computer server over a wireless communication network and generating a digital graphical user interface (GUI) on an electronic display of the first computing device with a plurality of digital data input fields operably configured to receive alpha-numeric text; and initiating a network-based remote do-it-yourself contract formation session that includes generating a digital document on the electronic display of the first computing device, with a plurality of independent preformed paragraphs each having at least one digital data input field therein, and filling in the at least one digital data input field with contract formation data to create a finalized digital document.

Additional embodiments of the computer-implemented and interactive real estate contract generation and editing process include providing a first electronic computing device of a first user and having an electronic display configured to display a digital graphical user interface (GUI) and a computer server, communicatively coupling the first electronic computing device of the first user to the computer server over a wireless communication network, and initiating a network-based remote easy contract formation session. The network-based remote easy contract formation session may beneficially include generating a plurality of independent and sequentially viewable windows on the GUI of the electronic display of the first electronic computing device, wherein each of the independent and sequentially viewable windows displaying at least one contract formation text therein and at least one digital data input field, receiving alpha-numeric text corresponding to contract formation data within each of the plurality of digital data input fields from the first user, executing a software-based learning tool ascertaining the contract formation data and comparing it to a learning data structure to ascertain a match corresponding to a user understanding of the at least one contract formation text associated with each of the independent and sequentially viewable windows, and generating, after completion of the plurality of independent and sequentially viewable windows and at a conclusion of the network-based remote easy contract formation session, a digital document with a plurality of independent paragraphs each having at least one fillable contract data field disposed therein and assigned to and filled in with at a portion of software-defined and software-selected contract formation data using the software-based learning tool to create a finalized digital document without any fillable contract data field therein.

Additional embodiments of the invention include plurality of digital data input fields each being identified by an assigned array index on an array data structure.

Further embodiments of the invention may include the plurality of digital data input fields each having a GUI informational icon disposed proximal to each of the plurality of digital data input fields, the GUI informational icon having informational text included therein and displaying the informational text on the electronic display of the first computing device upon selectively modulating the GUI informational icon.

A computer-implemented and interactive real estate contract generation and editing process is also disclosed that includes providing a first electronic computing device of a first user and having an electronic display configured to display a digital graphical user interface (GUI) and a computer server, communicatively coupling the first electronic computing device of the first user to the computer server over a wireless communication network, and initiating a network-based remote easy contract formation session. The network-based remote easy contract formation session may also include generating a plurality of independent and sequentially viewable windows on the GUI of the electronic display of the first electronic computing device, wherein each of the independent and sequentially viewable windows displaying at least one contract formation text therein and at least one digital data input field identified by an assigned array index on an array data structure, receiving alpha-numeric text corresponding to contract formation data within each of the plurality of digital data input fields from the first user, and generating, after completion of the plurality of independent and sequentially viewable windows and at a conclusion of the network-based remote easy contract formation session, a digital document with a plurality of independent preformed paragraphs each having at least one fillable contract data field disposed therein and assigned to, using the array data structure with the assigned array index, and filled in with contract formation data received within each of the plurality of digital data input fields from the first user to create a finalized digital document without any fillable contract data field therein.

Although the invention is illustrated and described herein as embodied in a computer-implemented and interactive real estate contract generation and editing process, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a block diagram of a computer-implemented and interactive real estate contract generation and editing process, in accordance with one exemplary embodiment of the present invention;

FIG. 2 is a block diagram of the exemplary computing device utilized in the computer-implemented and interactive real estate contract generation and editing process of FIG. 1, in accordance with the present invention;

FIG. 3 is a process flow diagram depicting the steps associated with the computer-implemented and interactive real estate contract generation and editing process of FIG. 1, in accordance with one exemplary embodiment of the present invention;

FIG. 4 is a screen shot view of a sign-up page for users, in accordance with an exemplary embodiment of the present invention;

FIG. 5 is a screen shot view of a verification by email page for users, in accordance with the present invention;

FIGS. 6-7 are screen shot views of a verification by phone page for users, in accordance with the present invention;

FIG. 8 is a screen shot view of a sign-in page for users, in accordance with the present invention;

FIG. 9 is a screen shot view of a forgot-your-password page for users, in accordance with the present invention;

FIG. 10 is a screen shot view depicting the plurality of digital graphical user interface (GUI) icons of the computer-implemented and interactive real estate contract generation and editing process of FIG. 1, in accordance with the present invention;

FIG. 11 is a screen shot view depicting the plurality of digital data input fields, in accordance with the present invention;

FIGS. 12-41 are screen shot views depicting the plurality of digital data input fields of the network-based remote easy contract formation session, in accordance with an exemplary embodiment of the present invention;

FIG. 42 is a screen shot view of a summary page of the network-based remote easy contract formation session, in accordance with the present invention;

FIGS. 43A-46B are screen shot views of the finalized digital document without any fillable contract data field therein of the network-based remote easy contract formation session, in accordance with the present invention;

FIGS. 47A-47C, and 48 are screen shot views of the plurality of digital data input fields for selling a home, in accordance with the present invention;

FIGS. 49-50 are screen shot views of the plurality of digital data input fields for requesting a professional list of properties available for purchase that fit the user's inputted criteria, in accordance with the present invention;

FIG. 51 is a screen shot view of a confirmation page for requesting a professional list of properties available for purchase that fit the user's inputted criteria, in accordance with the present invention;

FIG. 52 is a screen shot view of a consultation request page, in accordance with the present invention;

FIG. 53A-53B is a screen shot view of a direct message chat between a user and a real estate professional, in accordance with the present invention;

FIG. 54A-54C is a screen shot view of a property listing page, in accordance with the present invention;

FIGS. 55A-62B are screen shot views depicting the plurality of digital data input fields in the network-based remote do-it-yourself contract formation session, in accordance with an exemplary embodiment of the present invention;

FIG. 63 is a screen shot view of a summary page of the network-based remote do-it-yourself contract formation session, in accordance with the present invention; and

FIGS. 64A-67B are screen shots of the finalized digital document without any fillable contract data field therein of the network-based remote do-it-yourself contract formation session, in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient computer-implemented and interactive real estate contract generation and editing process that enables users, namely, real estate sellers and purchasers, to draft, edit, and finalize real estate purchase and sale agreements themselves rather than having to be dependent or reliant on a third party to do so, e.g., on a real estate agent or attorney. Embodiments of the invention provide a process that may be performed remotely over a wireless communication network and from any geographic location for greater convenience. In addition, embodiments of the invention provide a contract generation and editing process that is simple and easy to perform such that it may be performed by professionals as well as users who are inexperienced in the real estate industry without sacrificing the substantive integrity of the contract. The present invention also beneficially enables a user to selectively toggle or switch between an “easy” mode and a “do-it-yourself” mode, wherein the “easy” mode poses specific, directed questions to the user, the responses to which are then inserted into the digital real estate contract to form the finalized digital document, whereas the “do-it-yourself” mode grants the user the ability to fill in digital data input fields directly onto the digital document itself until a finalized digital document is achieved. As used herein, the term “easy” is solely used for naming purposes and should not be construed otherwise or interpreted in any other matter.

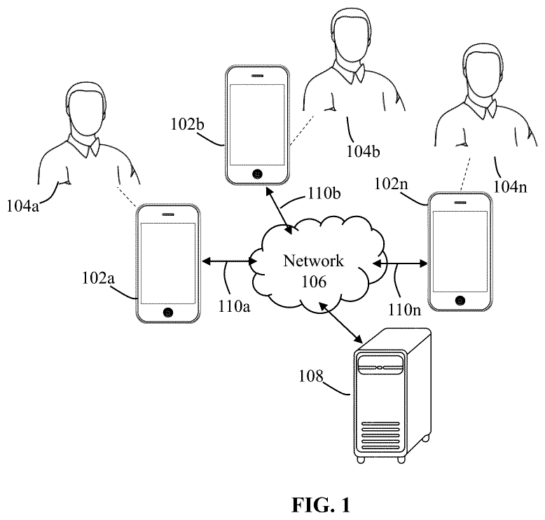

Referring now to FIG. 1, one embodiment of the present invention is shown in a block diagram view. FIG. 1 shows several advantageous features of the present invention, but, as will be described below, the invention can be provided in several shapes, sizes, combinations of features and components, and varying numbers and functions of the components. The first example of a computer-implemented and interactive real estate contract generation and editing process (referred to herein as the “process 300” for brevity), as shown in FIGS. 1-3, includes a first Step 302 of the process 300 which comprises providing a first electronic computing device 102a of a first user 104a, the electronic computing device 102a having an electronic display 210, a memory 206, a user input interface 202, and a network interface 204. In preferred embodiments, the first electronic computing device 102a may consist of a cell phone, smart phone, laptop, tablet, desktop computer, or other comparable electronic computing or processing device 208. The memory 206 is non-transitory wherein “non-transitory” is defined as a resident memory. The electronic computing devices 102a-n which may be a cellphone or tablet, for example, are operable to execute programming instructions embodied in the process 300 that can be received from a computer server 108 via a wide area network (WAN) 106. Said differently, the electronic computing devices 102a-n are operable to execute the programming instructions received from the computer server 108 over the WAN 106. In other embodiments, the process 300 is embodied in a web-based software application, a desktop software application, or a mobile device software app. In one embodiment, the WAN is the Internet. The Internet represents a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, the network 106 also may be implemented as a number of different types of networks, such as for example, an Intranet, a local area network (LAN), or a cellular network. FIG. 1 is intended as an example, and not as an architectural limitation for the present invention. As shown in FIG. 1, the network 106 includes connections 110a-n, which are the medium used to provide communication links between various devices and computers connected together within the network 106. The connections 110a-n may be wired or wireless connections, but said connections are preferably wireless. A few exemplary wired connections are cable, phone line, and fiber optic. Exemplary wireless connections include radio frequency (RF) and infrared radiation (IR) transmission. Many other wired and wireless connections are known in the art and can be used with the present invention.

The network interface 204 may include one or more network interface cards (NIC) or a network controller. In some embodiments, the network interface 204 may include a personal area network (PAN) interface. The PAN interface may provide the capability for the user's computing devices to network using a short-range communication protocol, for example, a Bluetooth communication protocol. The PAN interface may permit one personal computing device to connect wirelessly to another personal computing device via a peer-to-peer connection. The network interface 204 may also include a local area network (LAN) interface. The LAN interface may be, for example, an interface to a wireless LAN, such as a Wi-Fi network. The range of the LAN interface may generally exceed the range available via the PAN interface. Typically, a connection between two electronic devices via the LAN interface may involve communication through a network router or other intermediary device. Additionally, the network interface 204 may include the capability to connect to a wide area network (WAN) via a WAN interface. The WAN interface may permit a connection to, for example, a cellular mobile communications network. The WAN interface may include communications circuitry, such as an antenna coupled to a radio circuit having a transceiver for transmitting and receiving radio signals via the antenna. The radio circuit may be configured to operate in a mobile communications network, including but not limited to global systems for mobile communications (GSM), code division multiple access (CDMA), wideband CDMA (WCDMA), and the like.

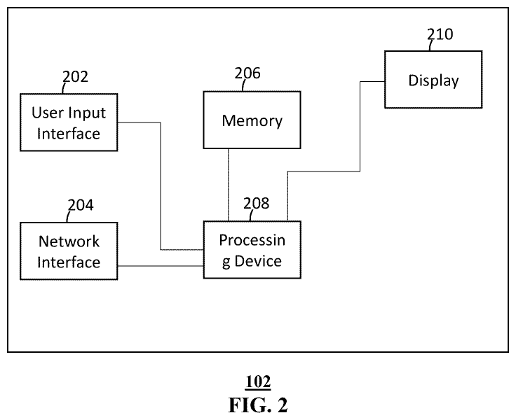

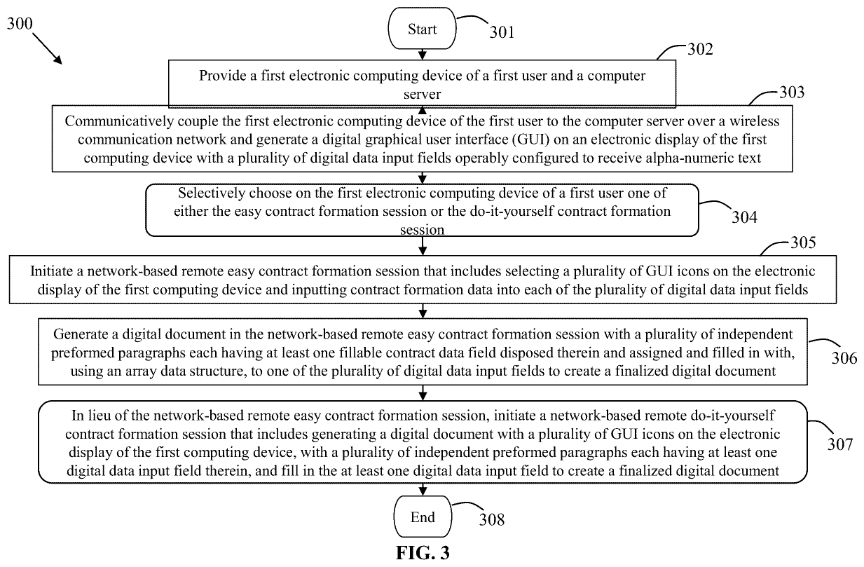

FIG. 3 will be described in conjunction with the process flow chart of FIGS. 1-2. Although FIG. 3 shows a specific order of executing the process 300 steps, the order of executing the steps may be changed relative to the order shown in certain embodiments. Also, two or more blocks shown in succession may be executed concurrently or with partial concurrence in some embodiments. Certain steps may also be omitted in FIG. 3 for the sake of brevity. In some embodiments, some or all of the process steps included in FIG. 3 can be combined into a single process.

A second Step 303 entails communicatively coupling the first electronic computing device 102a of the first user 104a to the computer server 108 over a wireless communication network 106 and generating a digital graphical user interface (GUI) 202 on an electronic display 210 of the first computing device 102a with a plurality of digital data input fields 1100a-n, wherein “n” refers to any number greater than one, operably configured to receive alpha-numeric text. In preferred embodiments, the process 300 is ran over a wireless communication network 106 though, as explained above, in alternate embodiments the process 300 may be run, for example, over wired networks. The plurality of digital data input fields 1100a-n may vary in form and substance. Specifically, the plurality of digital data input fields 1100a-n may be in the form of fill-in-the-blank input fields (as shown by 1100b), drop-down input fields (as shown by 1100n), pre-determined response input fields (as shown by 1100a), or a combination of the foregoing. For this reason, the term “alpha-numeric text” is defined as numerals, letters, punctuation, special characters, etc. whether pre-determined or inputted by the user. The specific substance of the plurality of digital data input fields 1100a-n may likewise vary in various embodiments but preferably relates to the contents of the real estate contract, e.g., identity of buyer(s), identity of seller(s), purchase price, method of payment (e.g., cash, loan, or other), length of offer, loan financing information, down payment information, title agent/company information, personal property, etc., wherein the foregoing subsets of information would be included only if and when applicable to the particular transaction at issue.

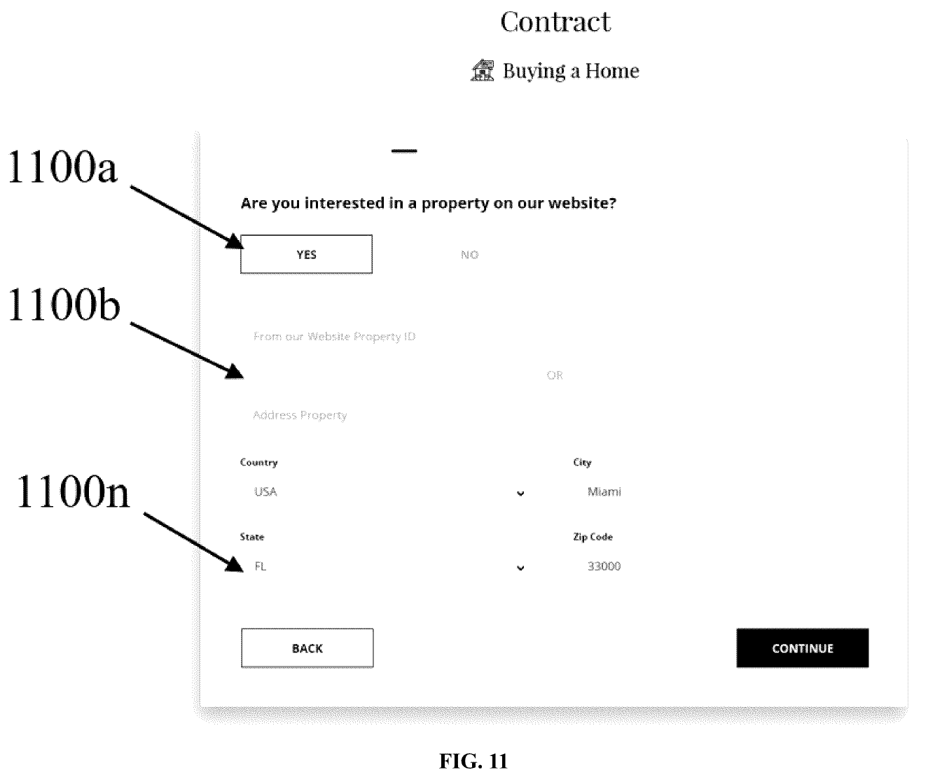

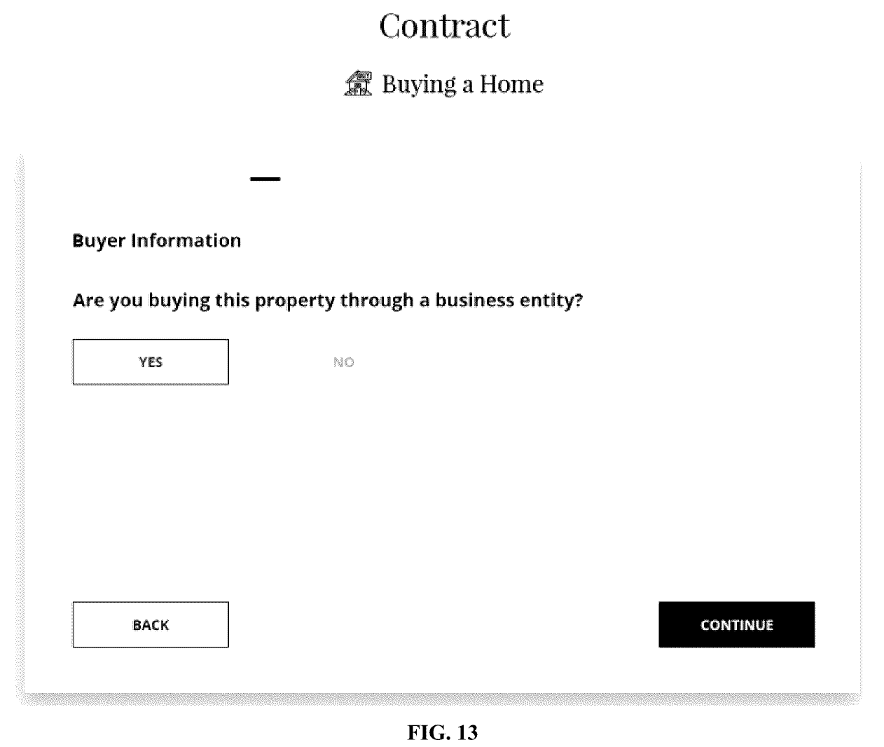

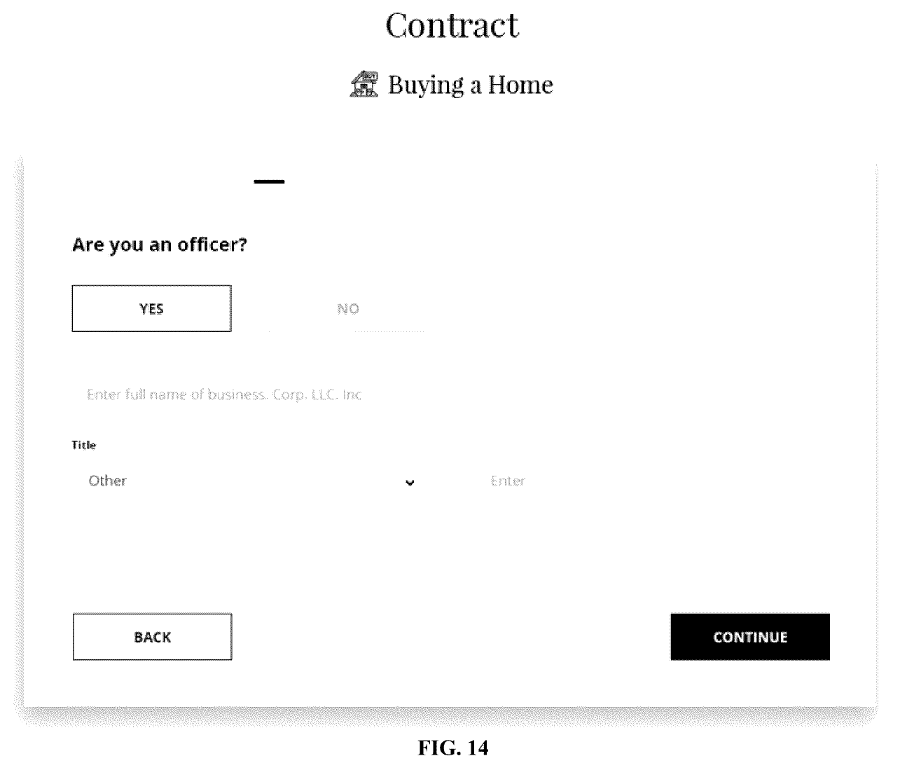

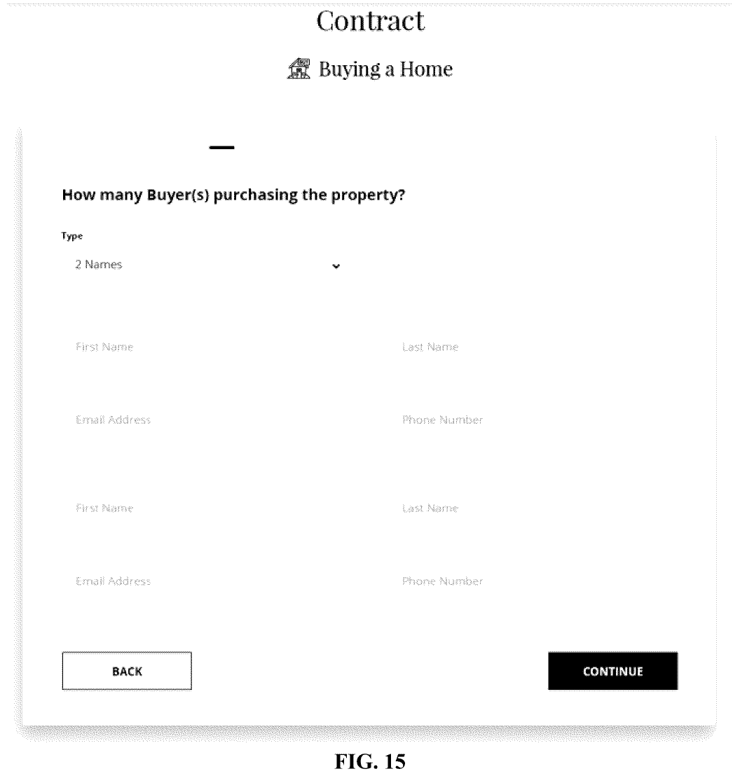

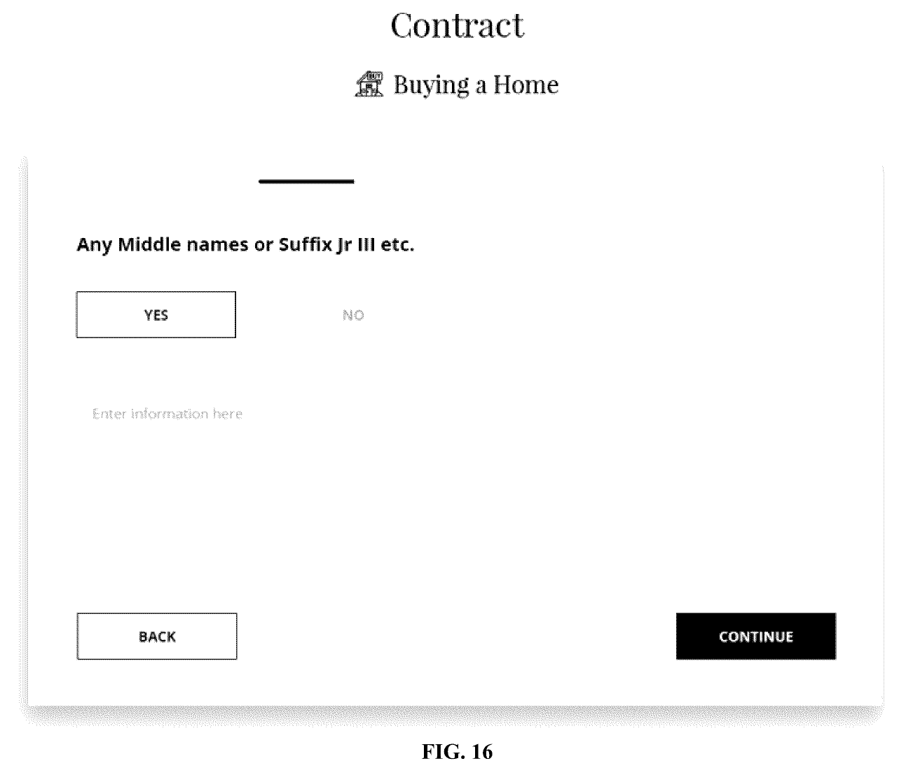

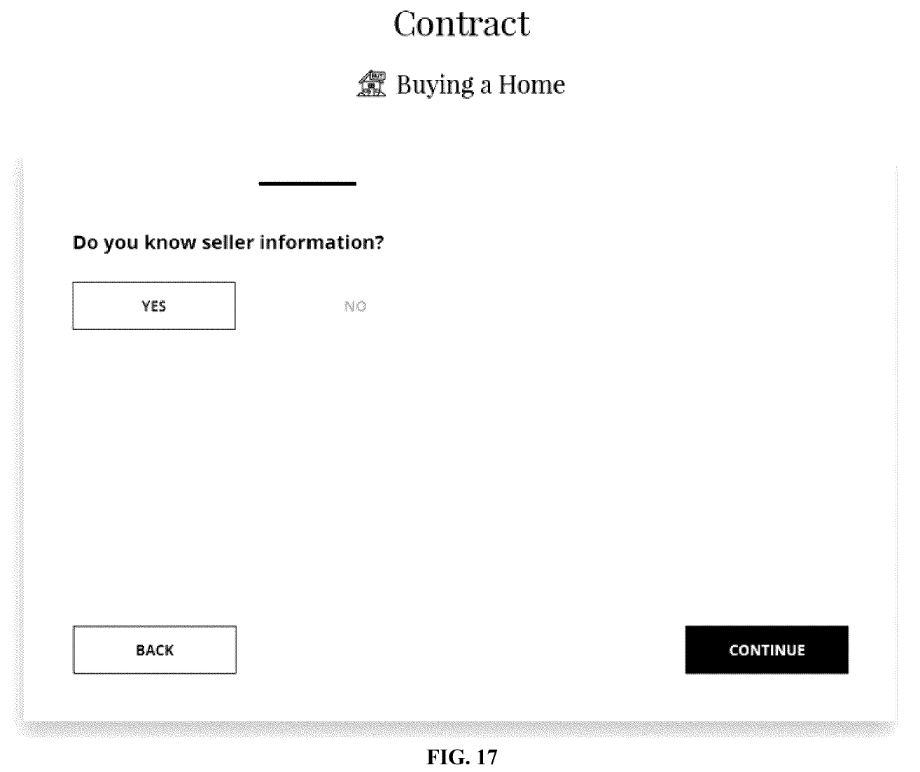

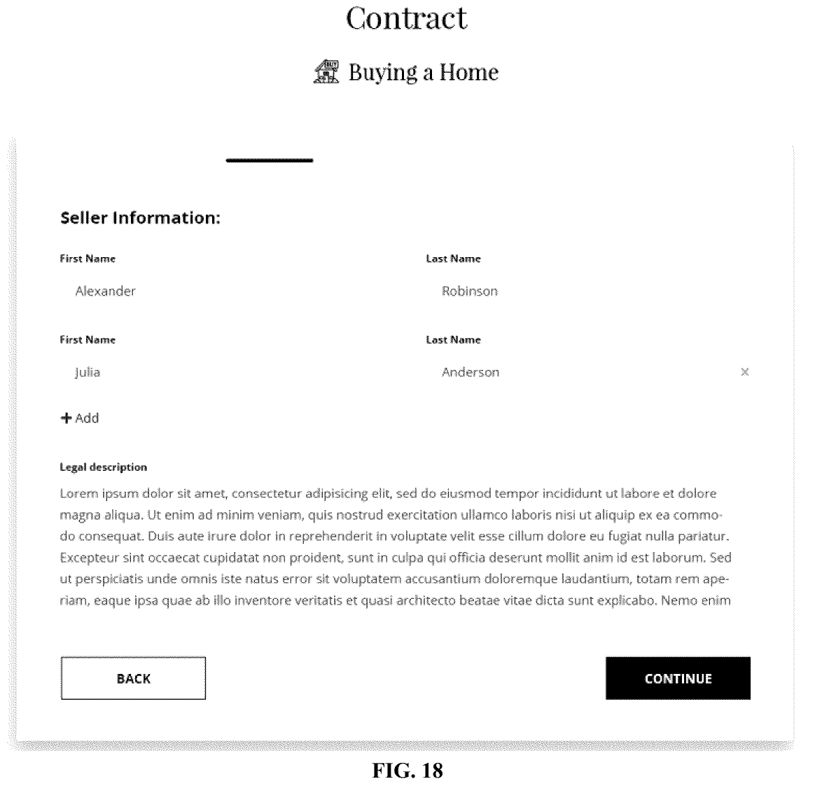

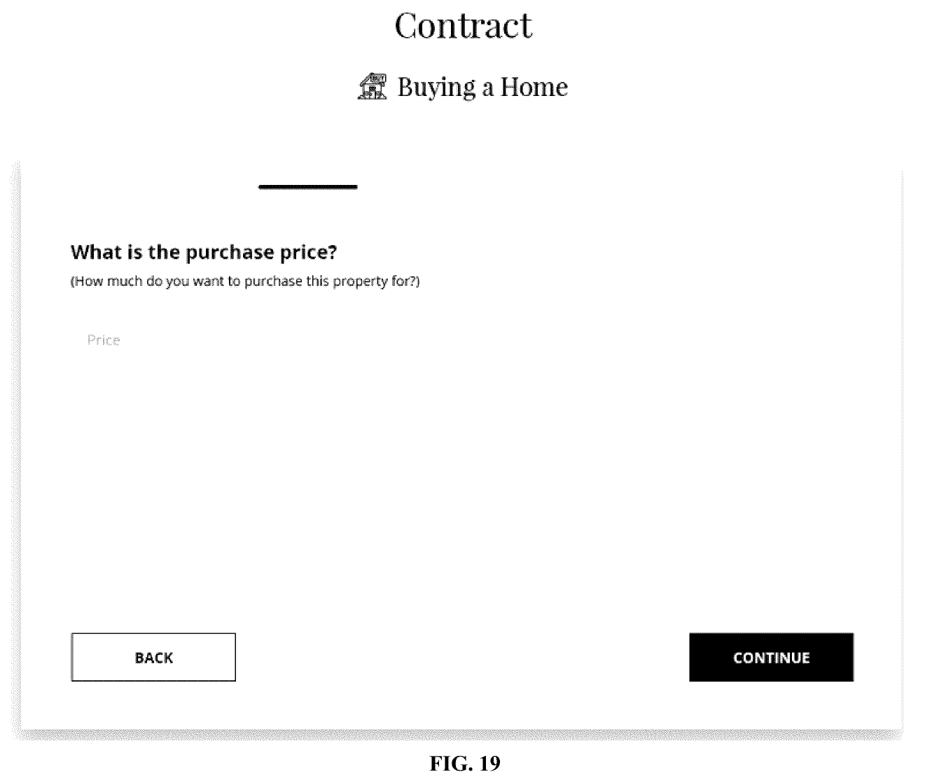

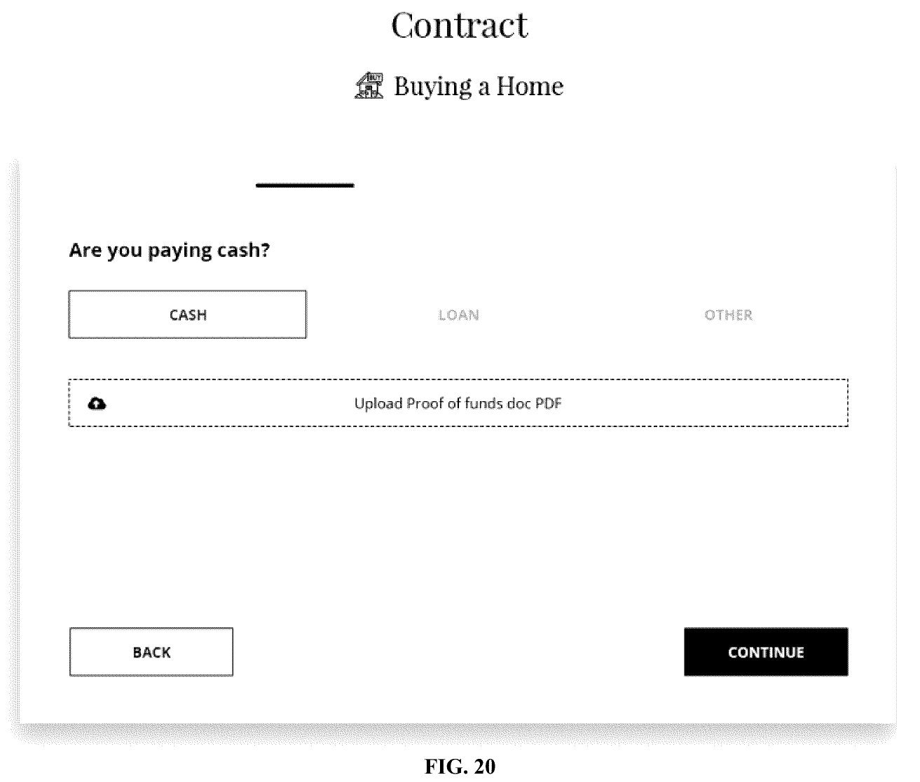

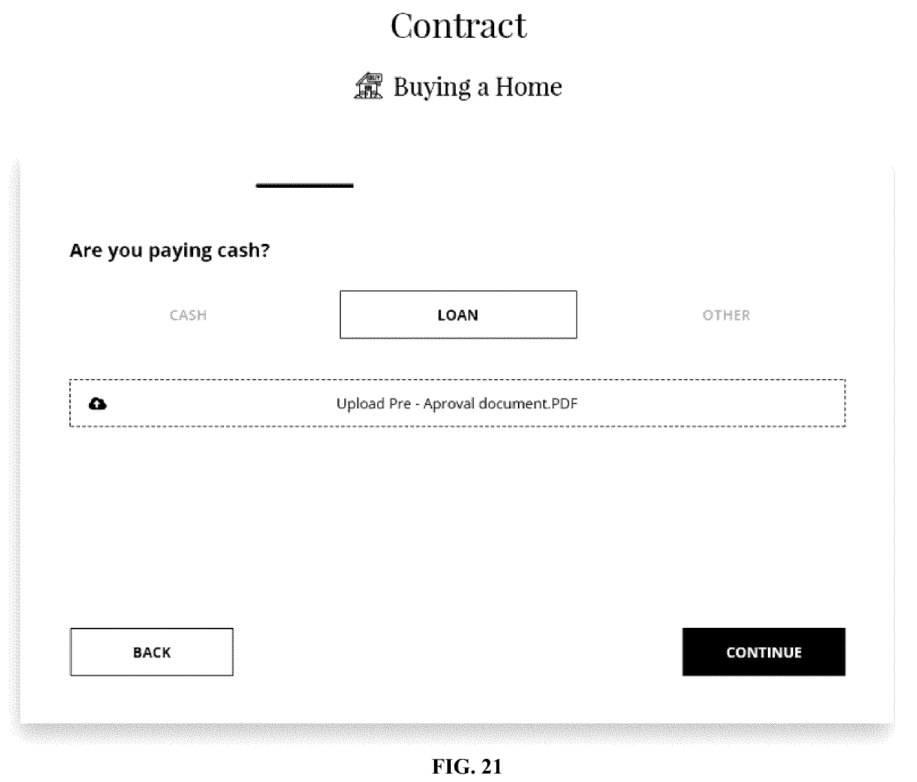

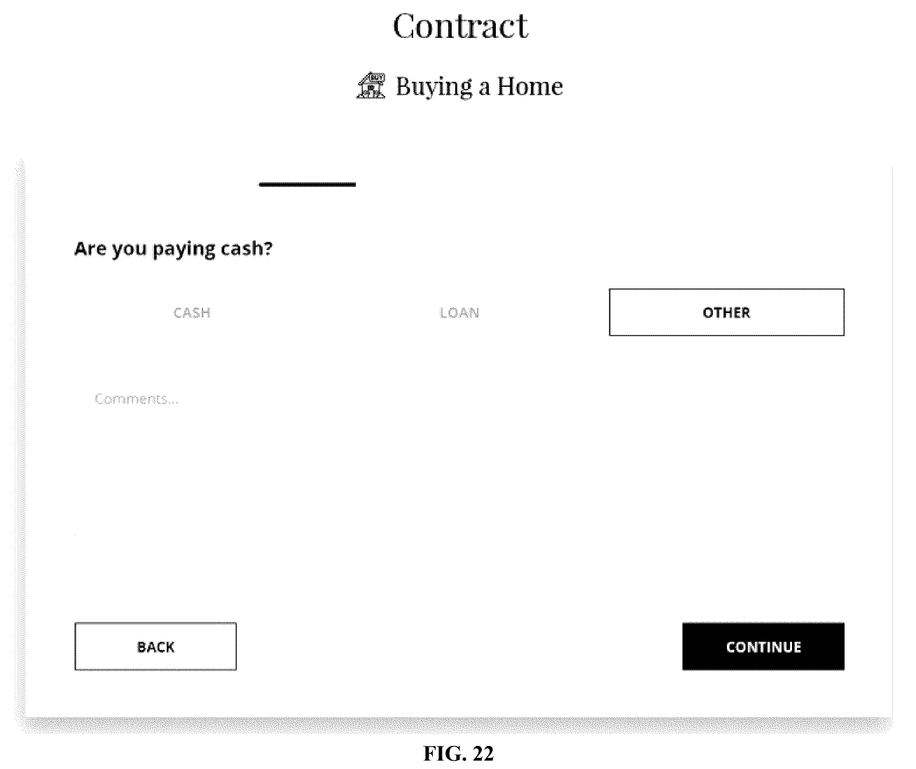

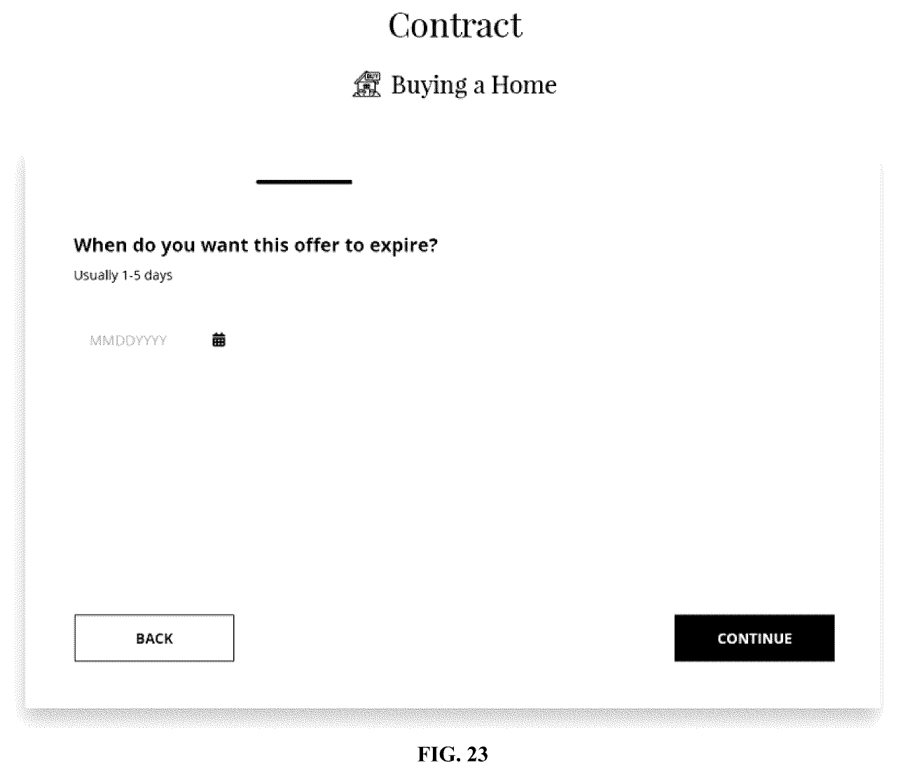

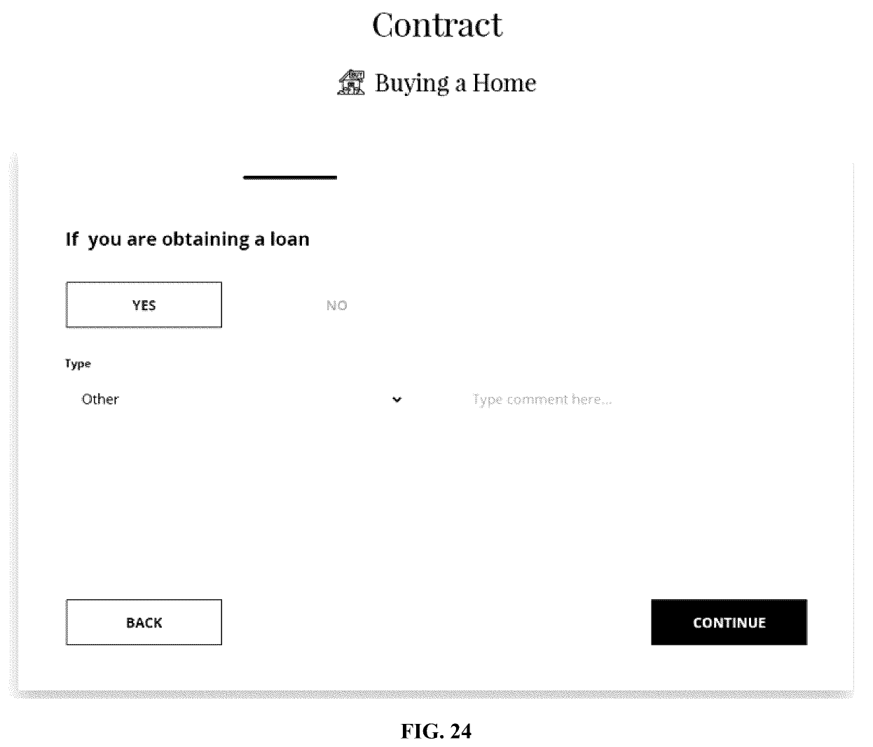

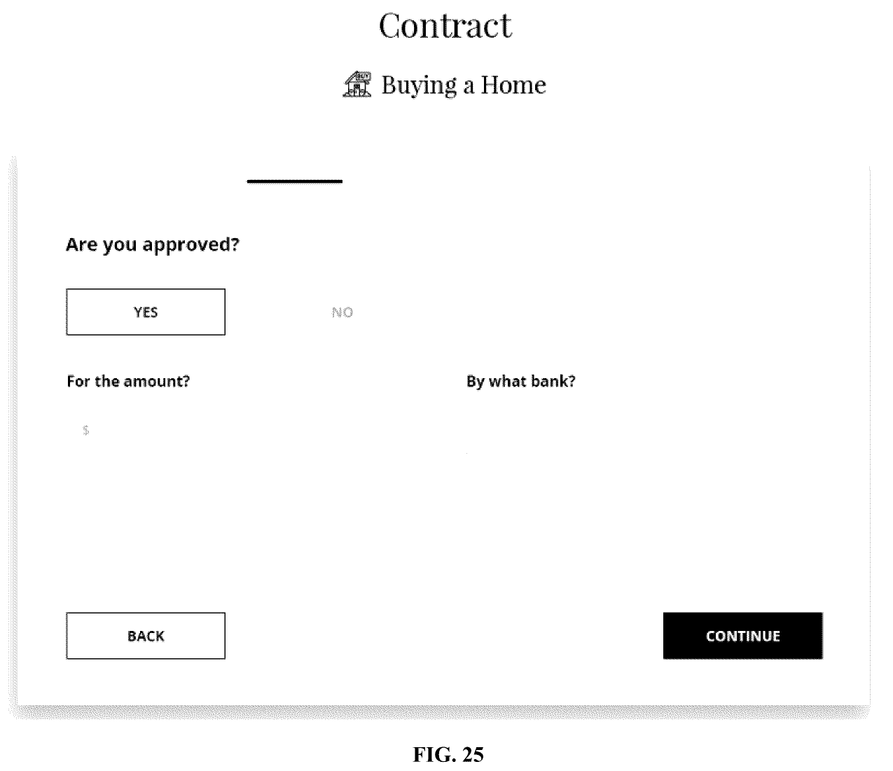

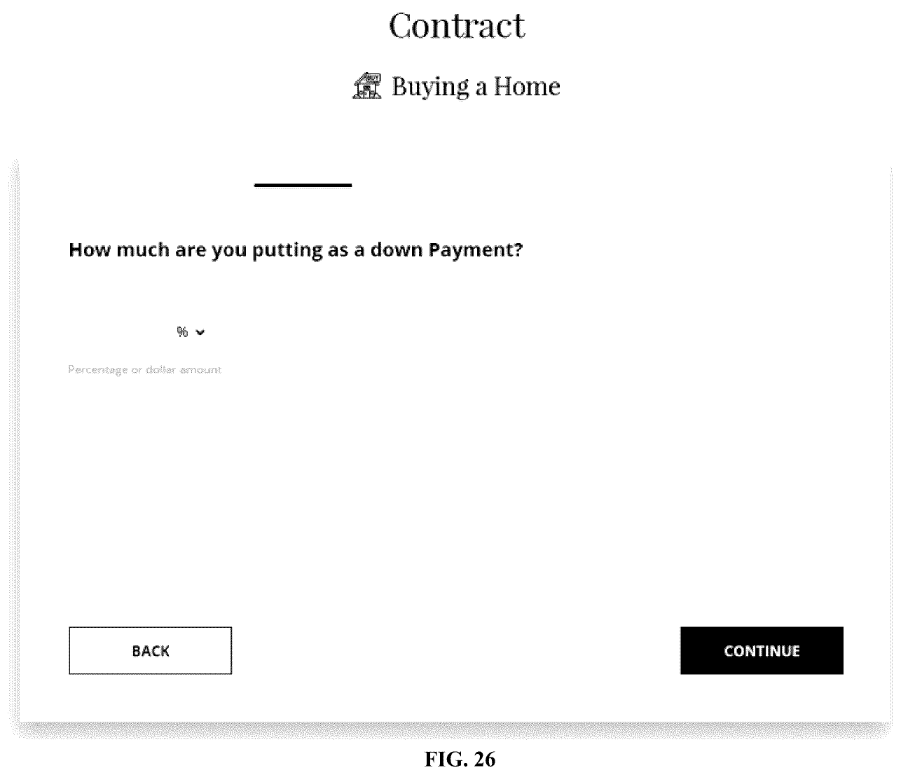

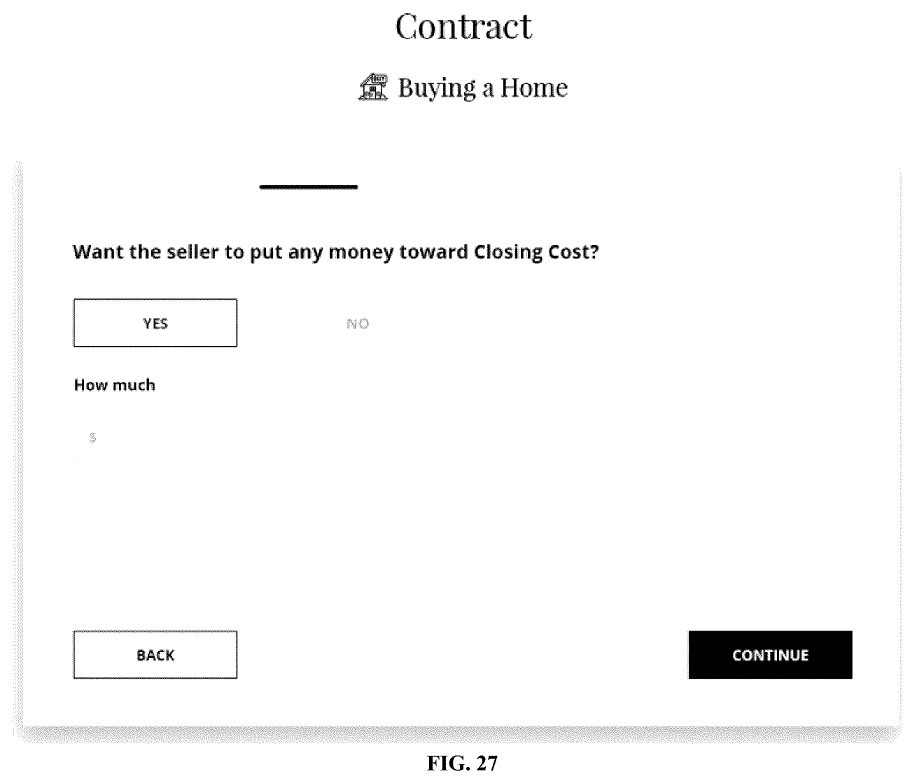

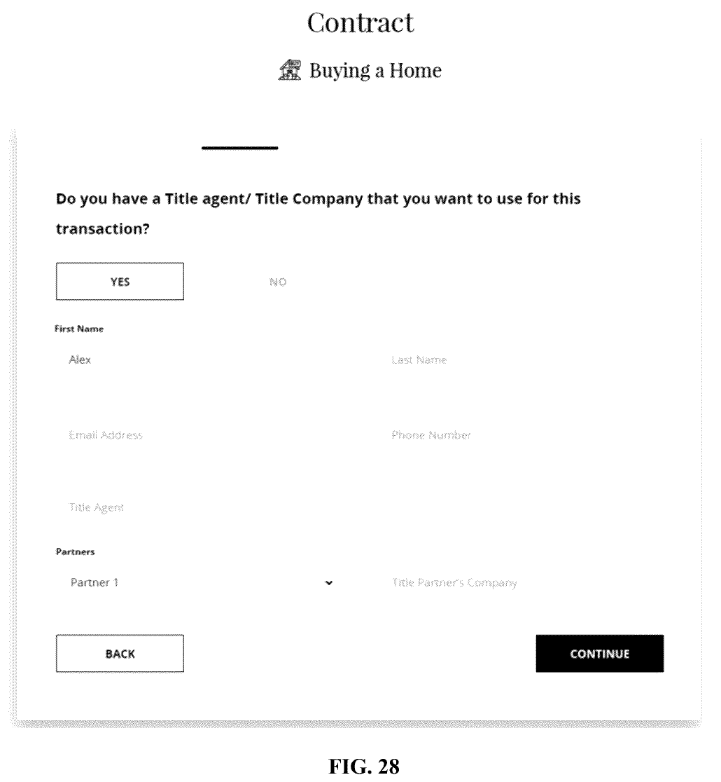

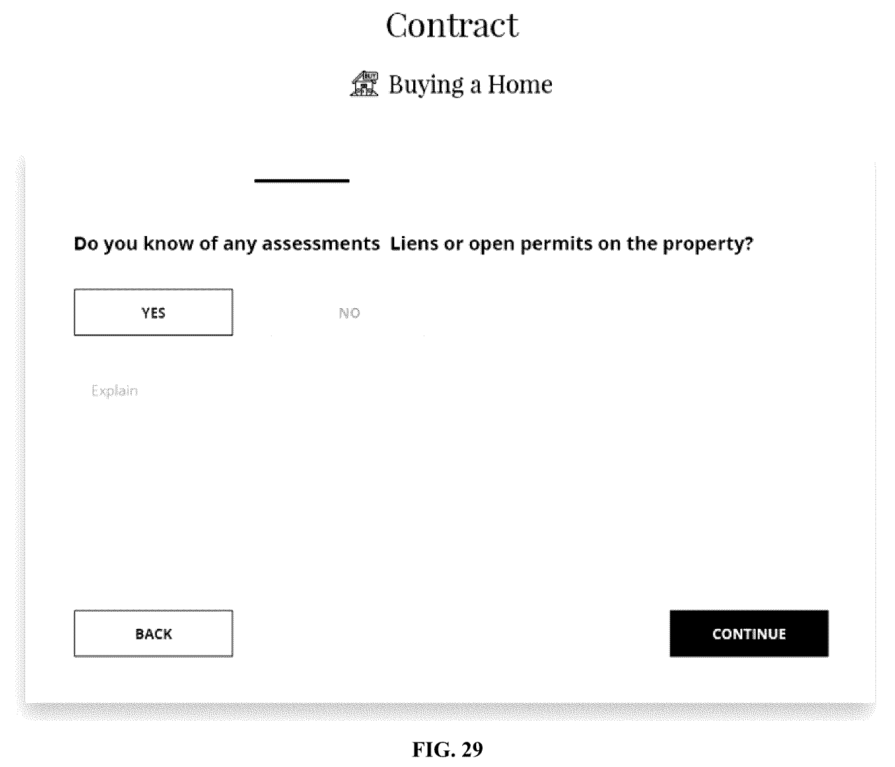

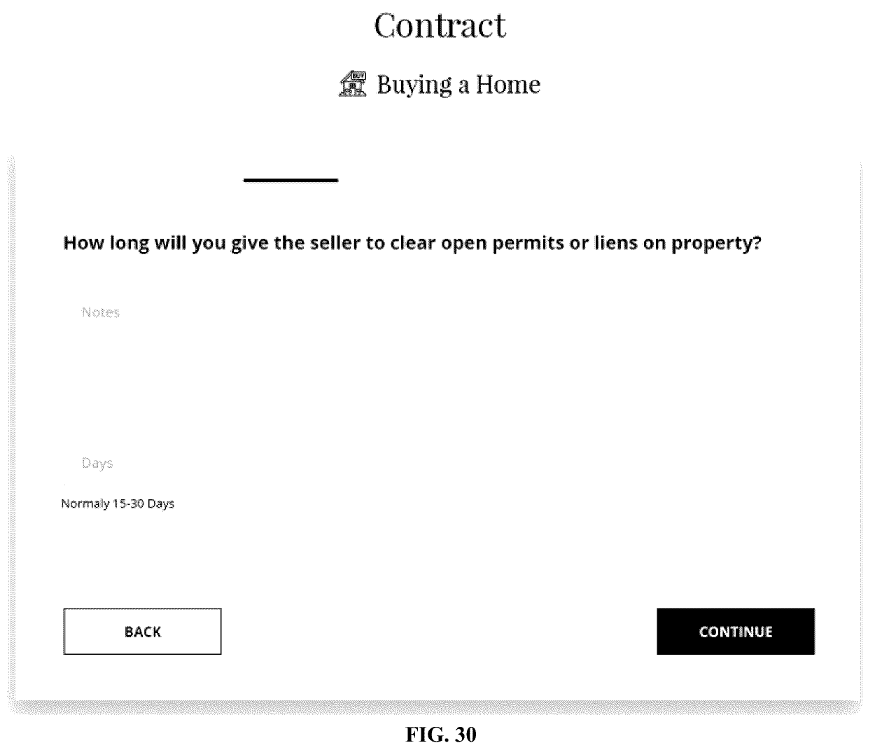

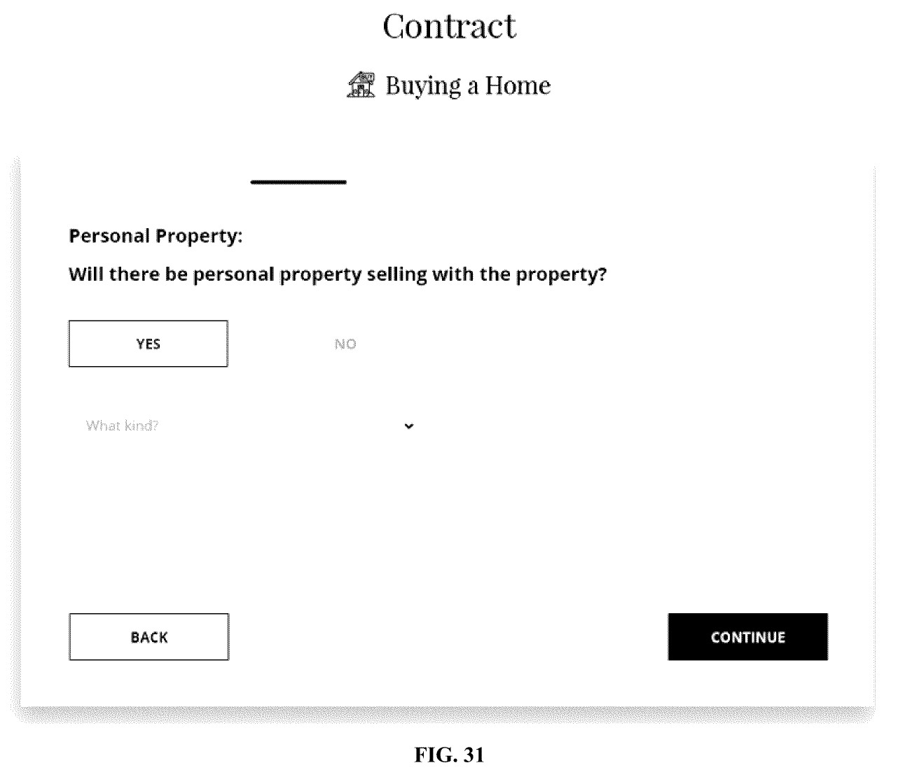

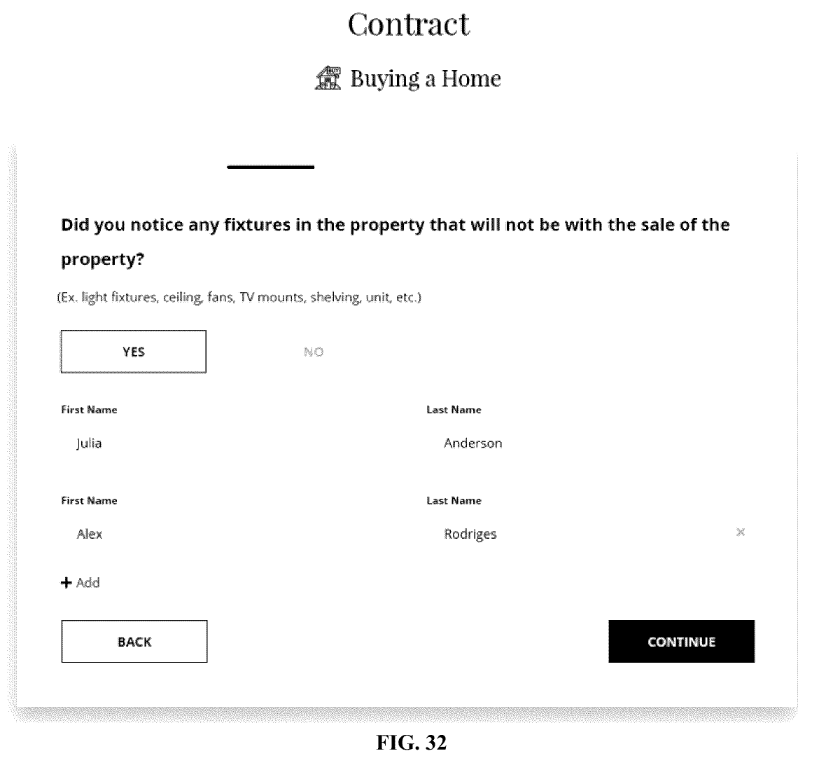

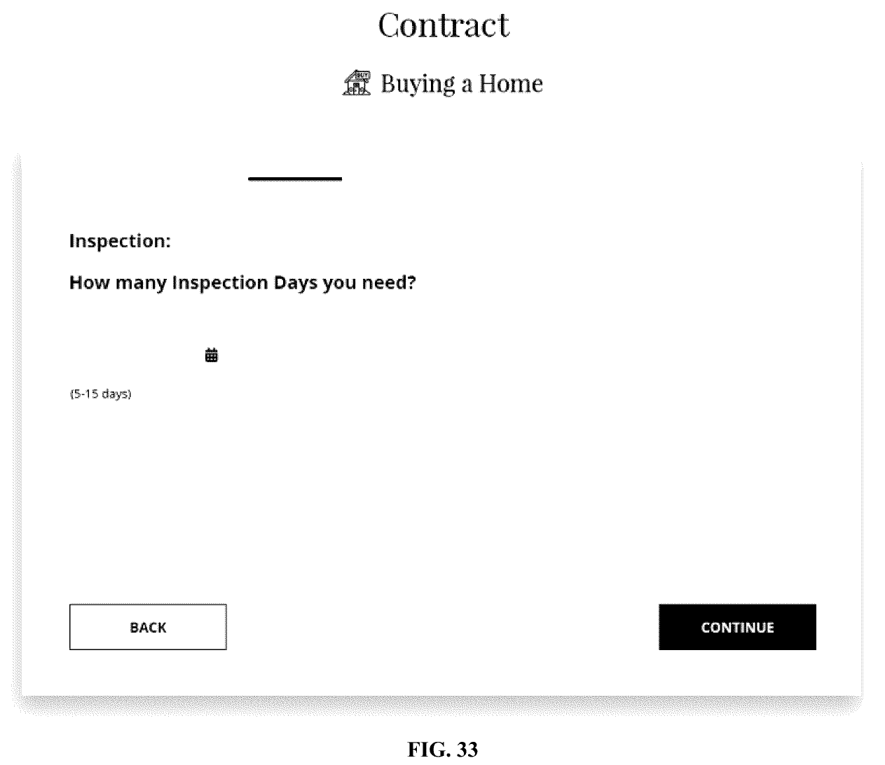

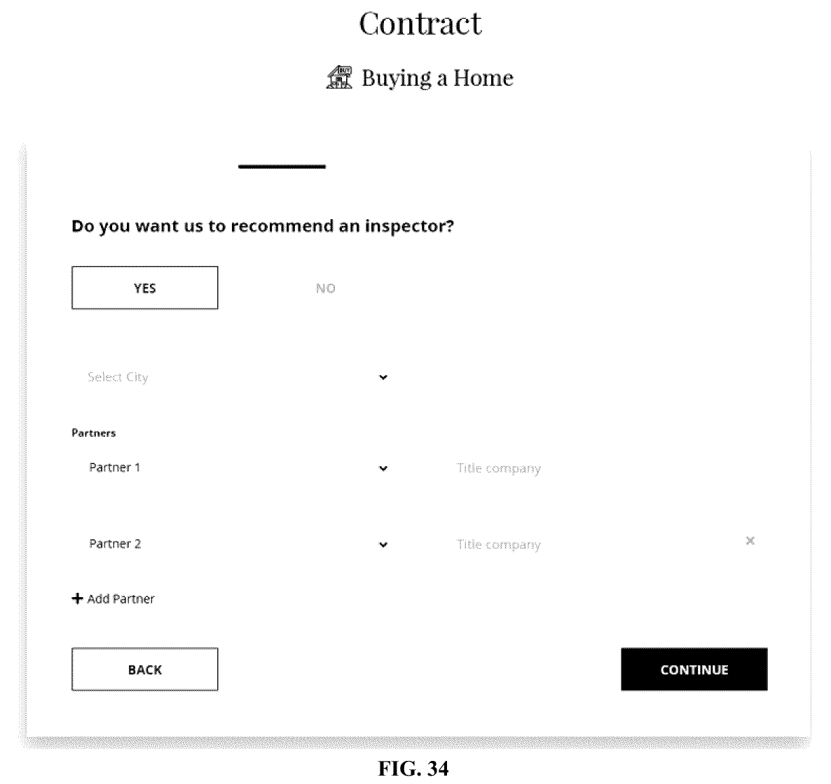

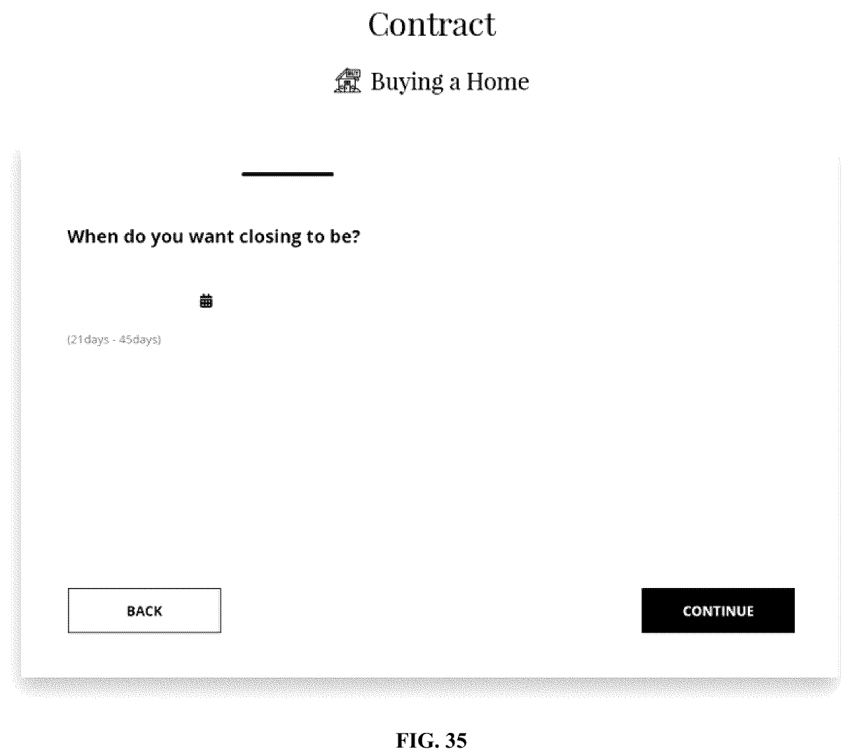

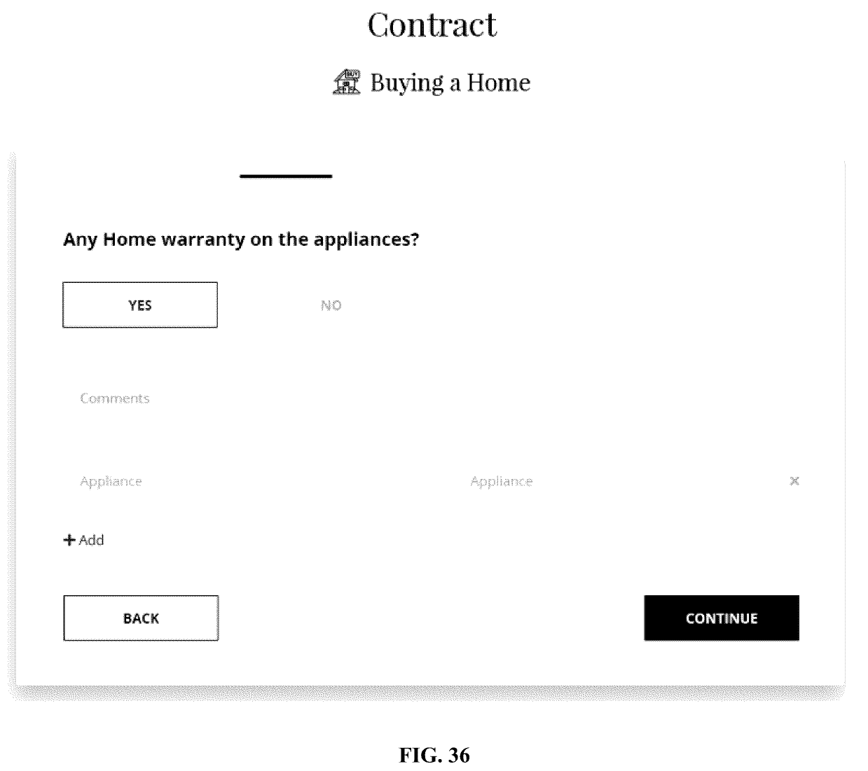

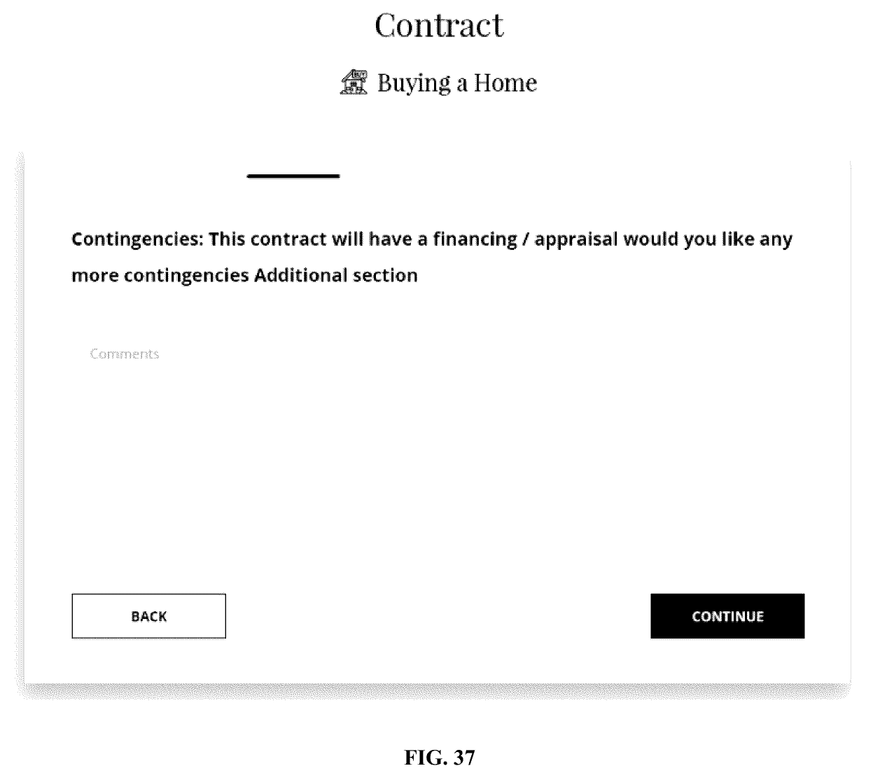

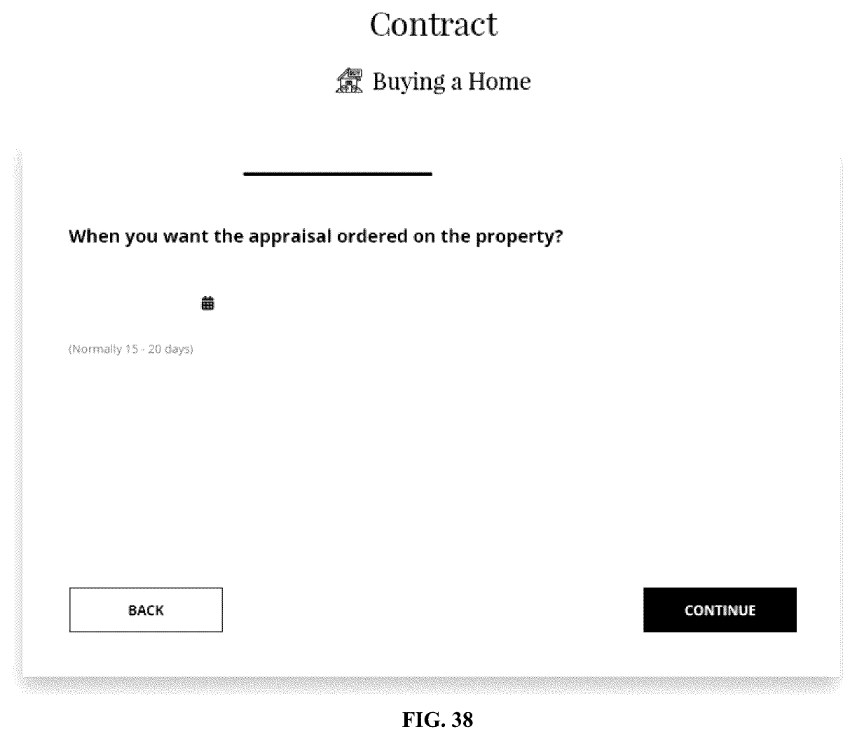

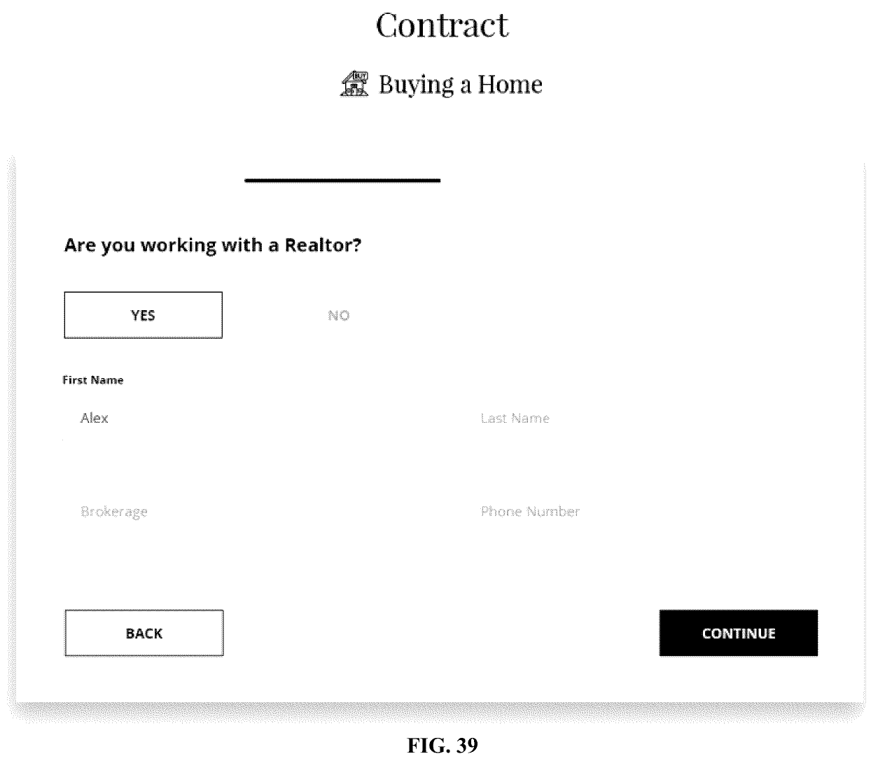

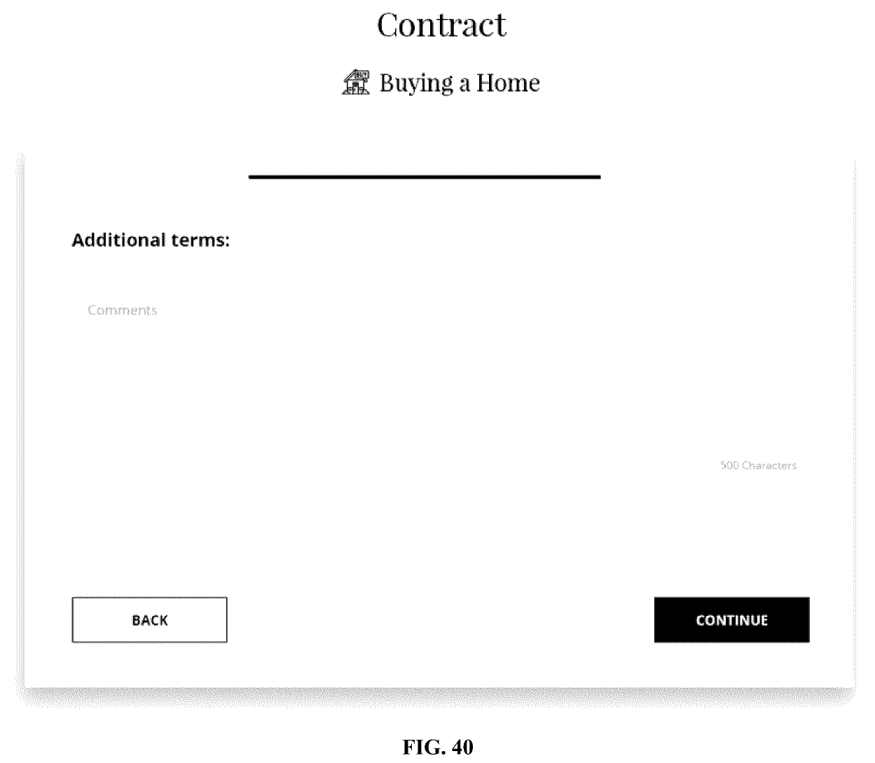

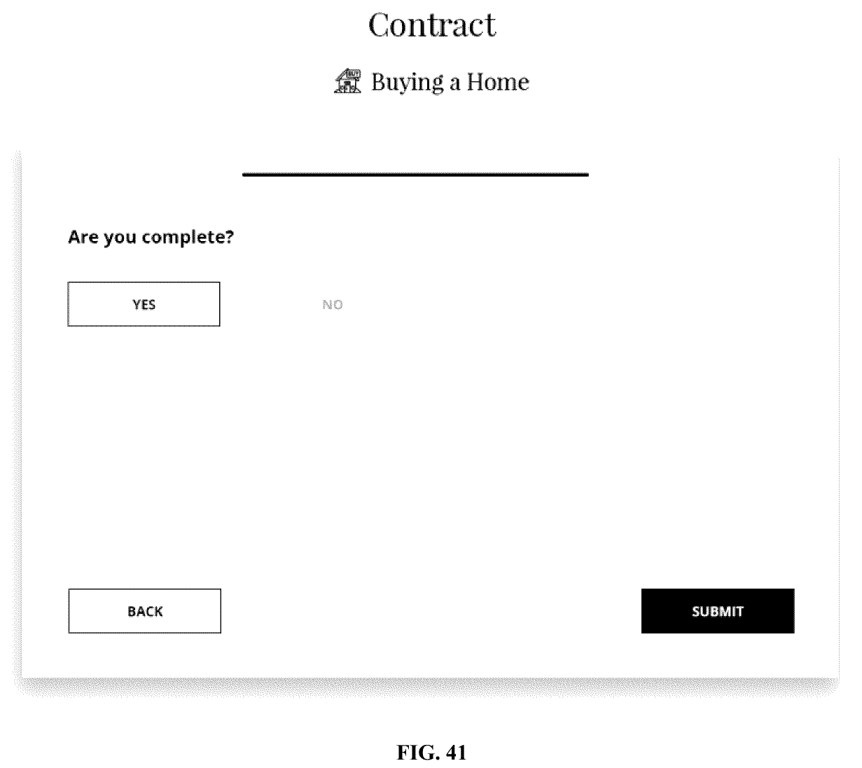

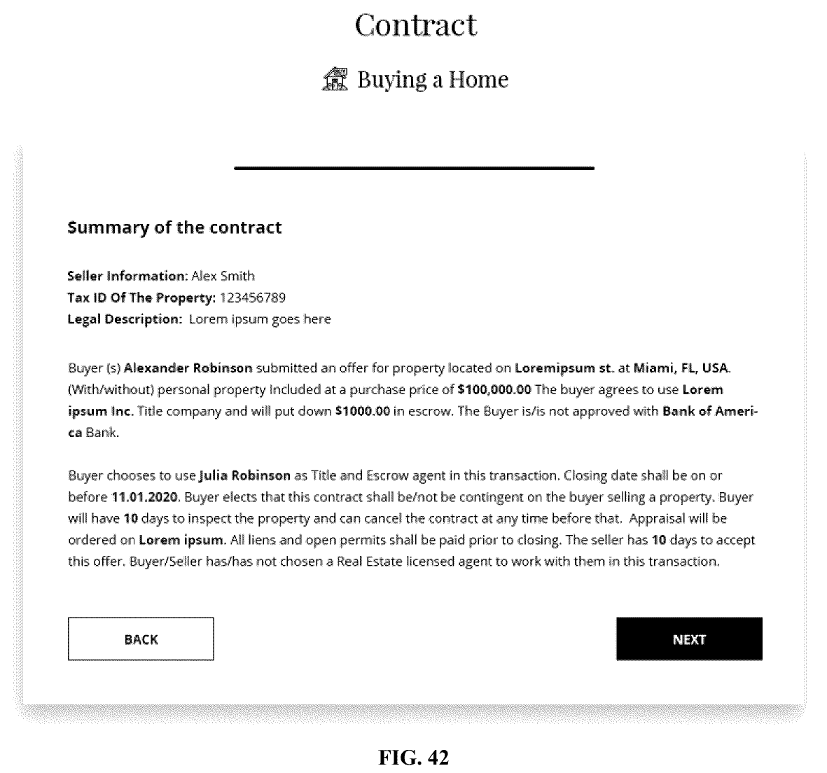

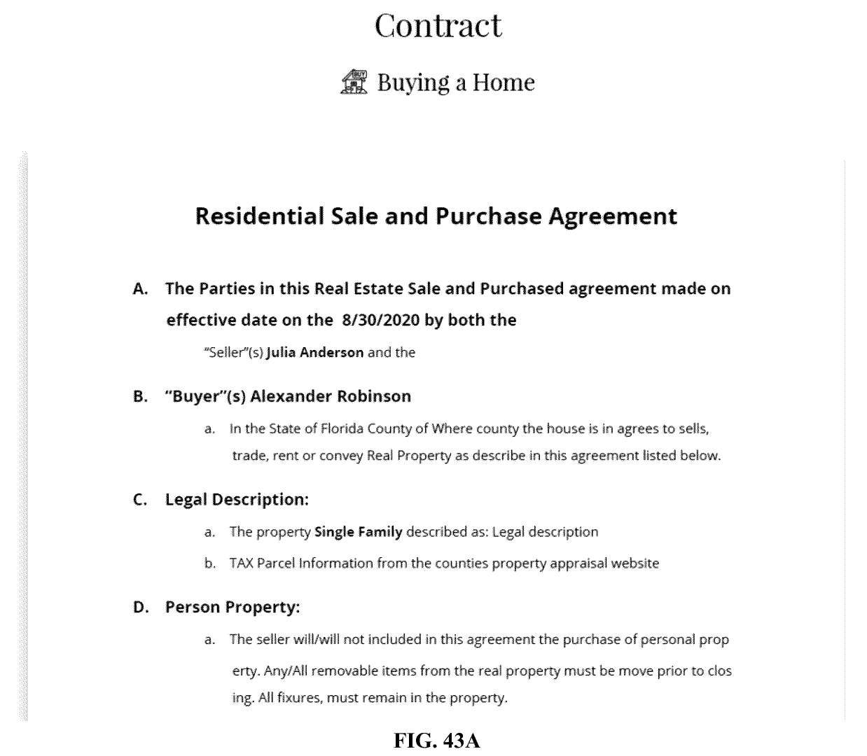

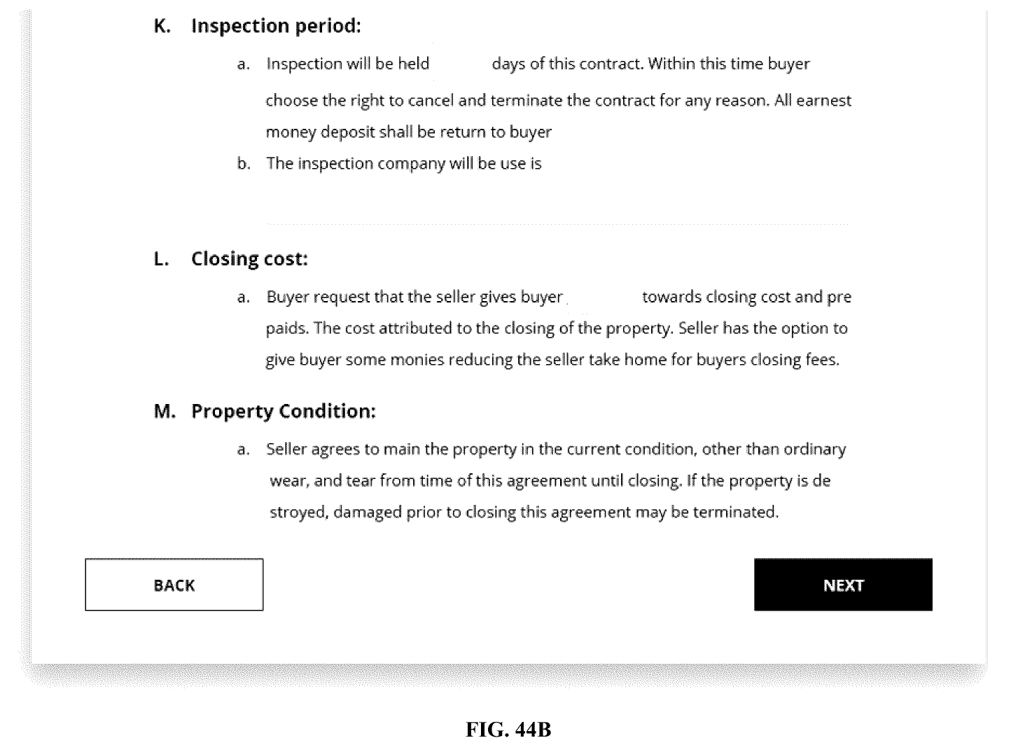

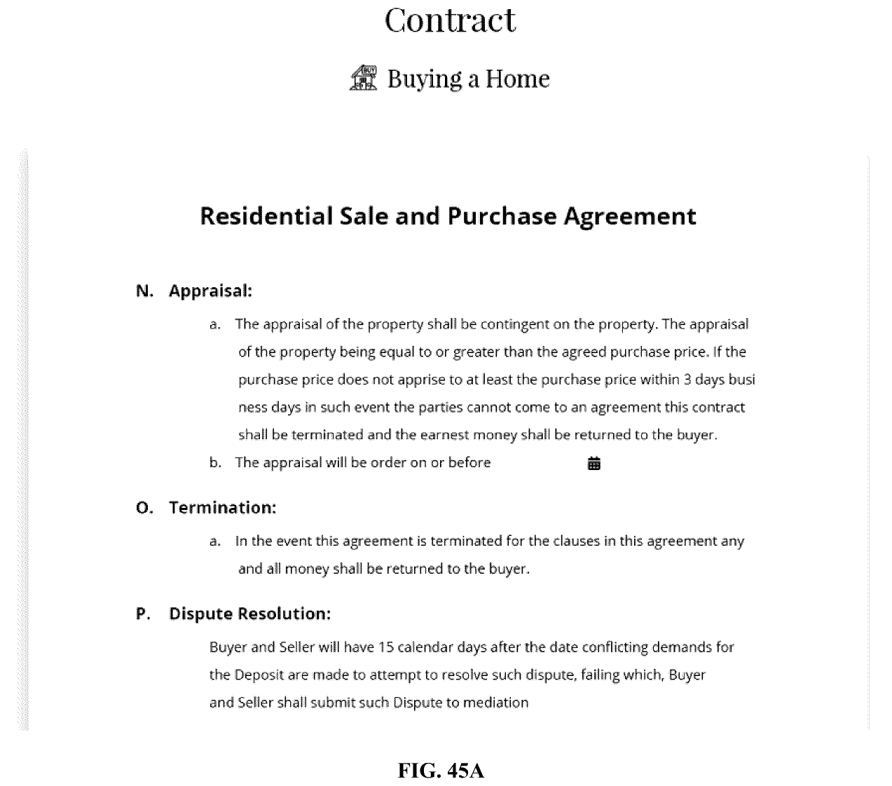

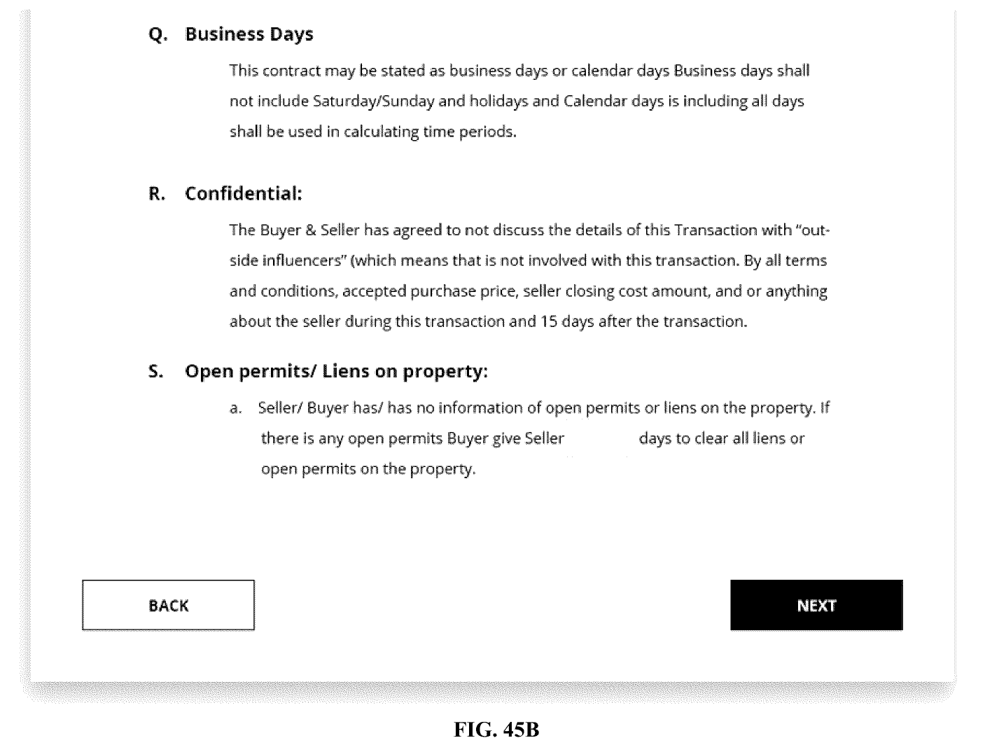

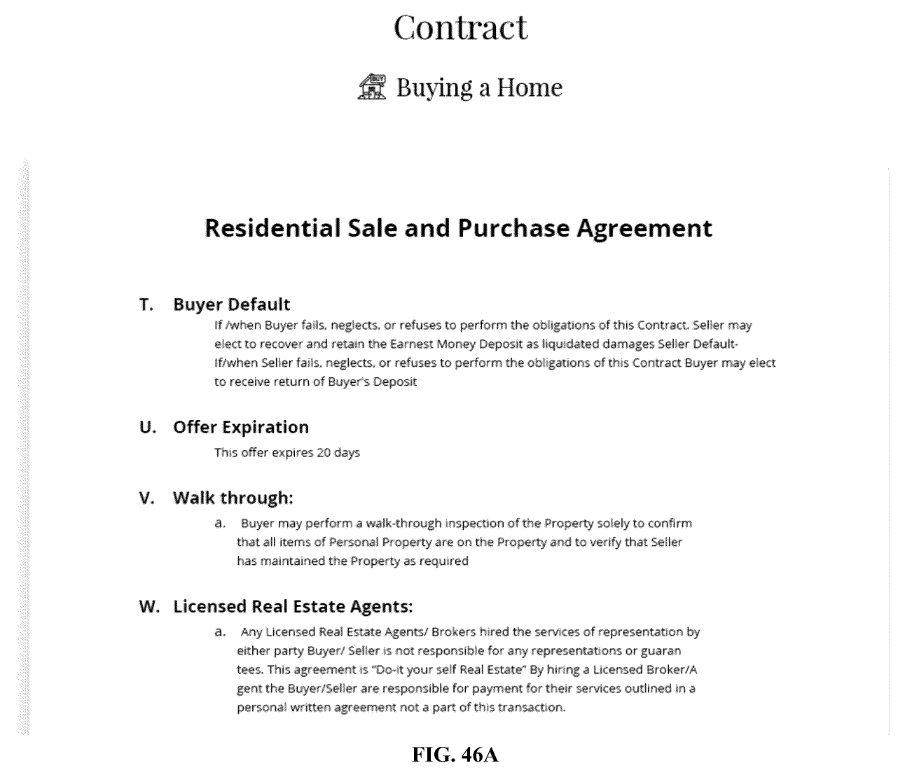

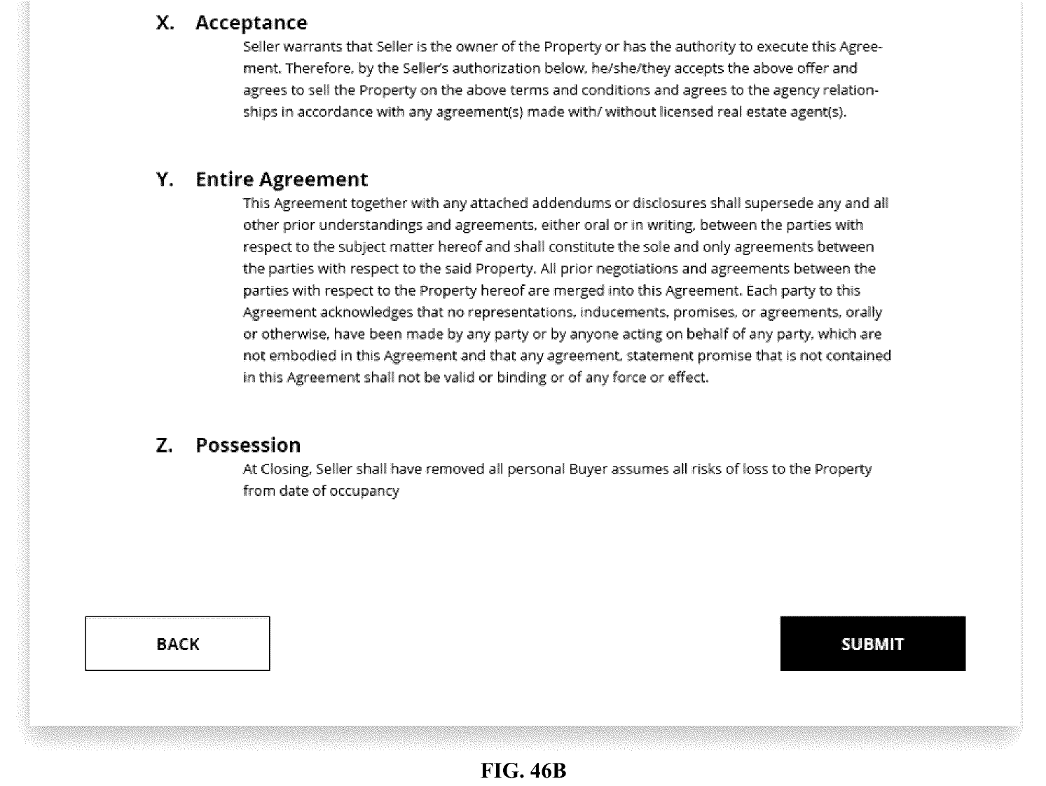

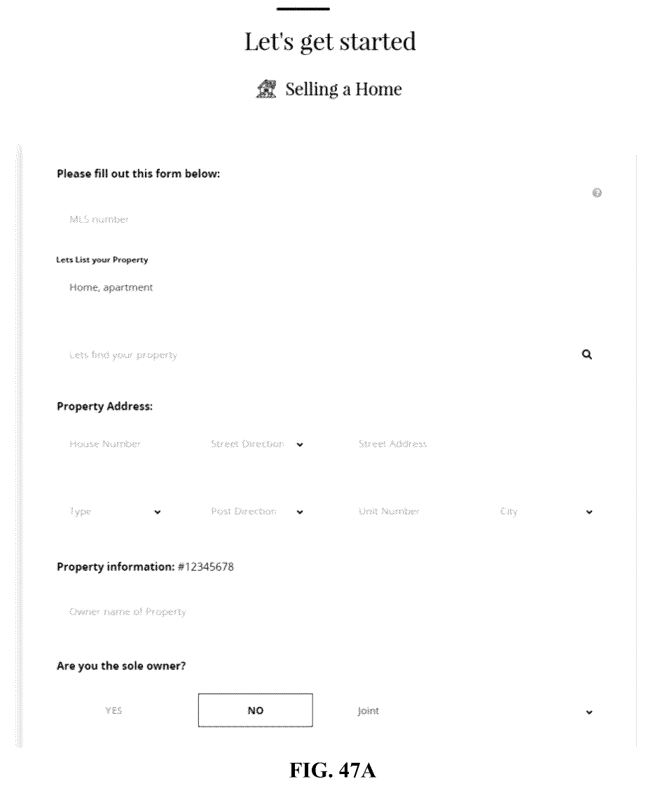

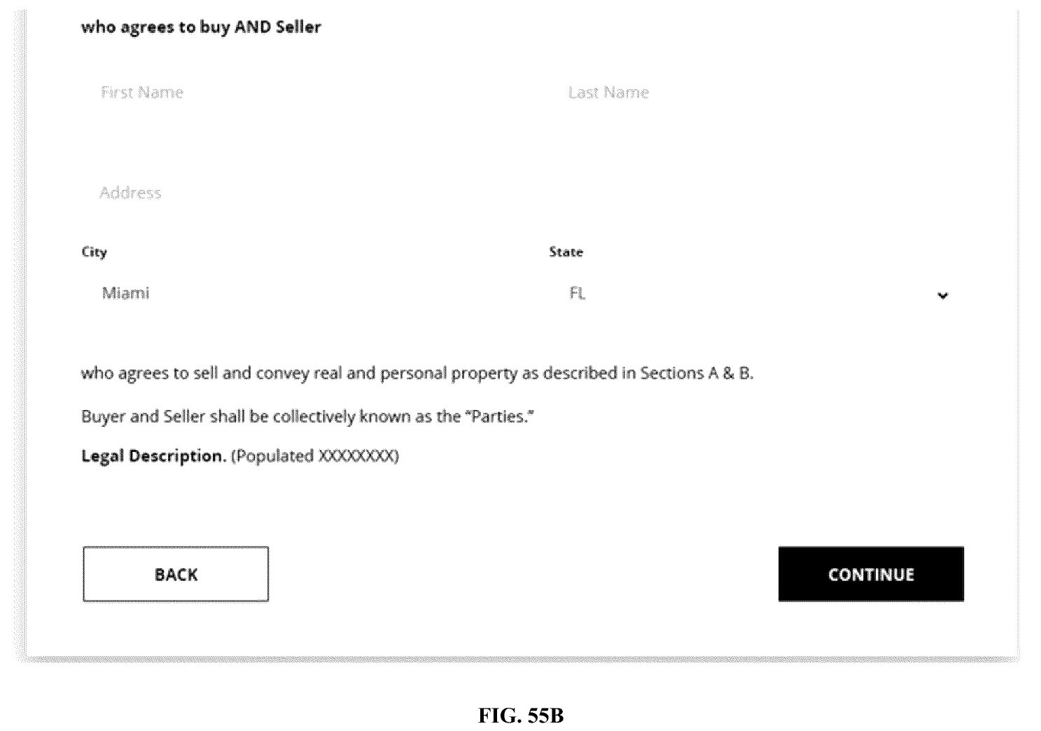

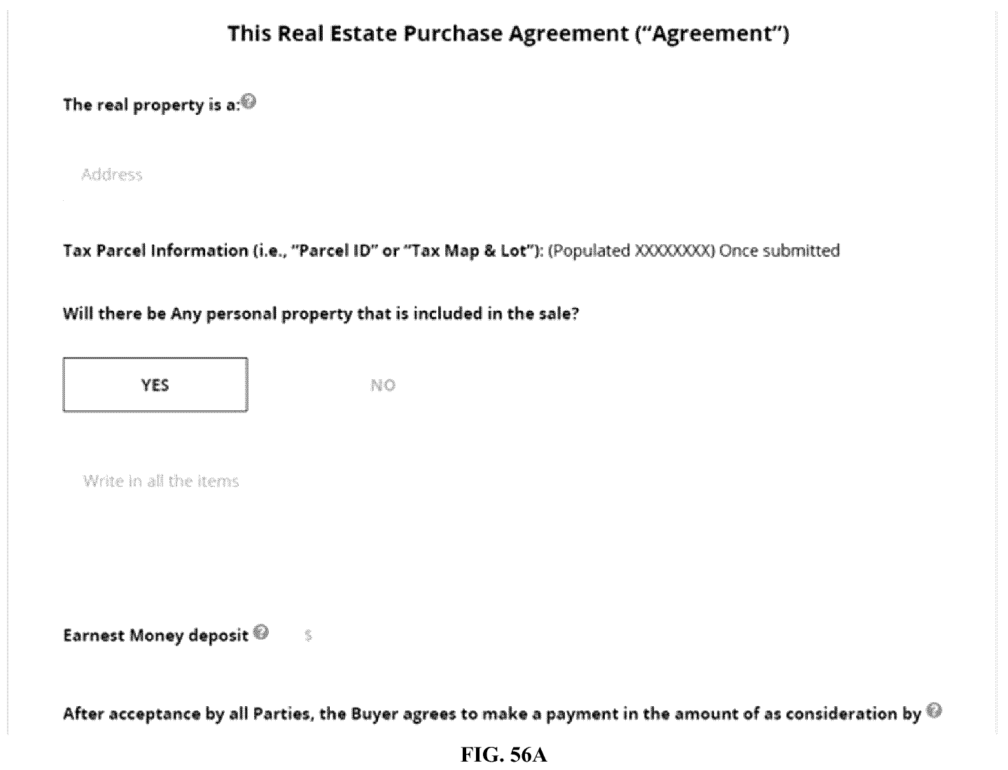

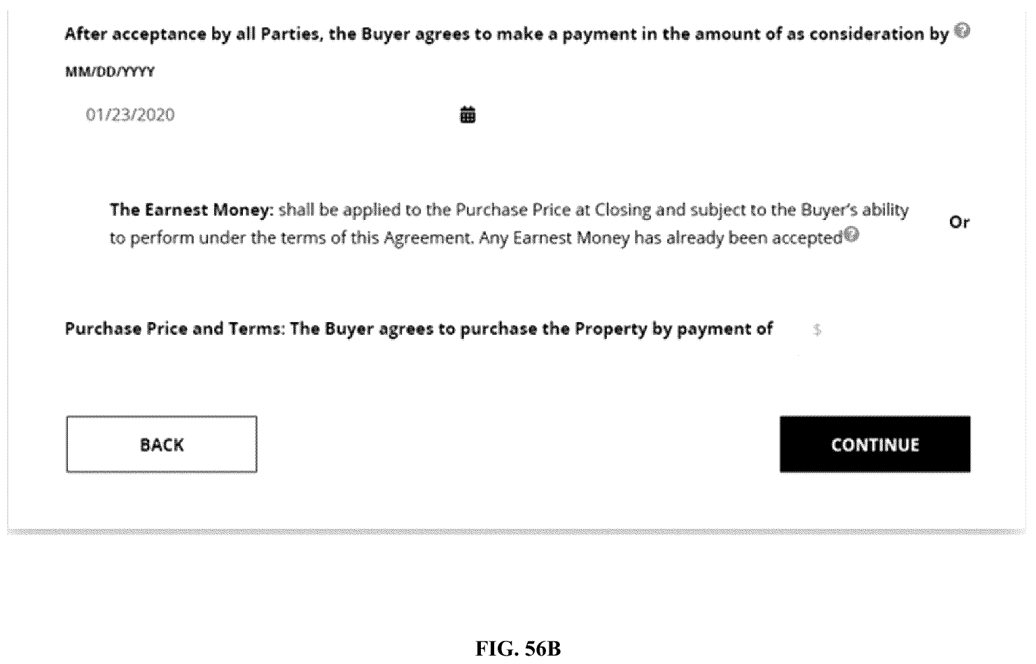

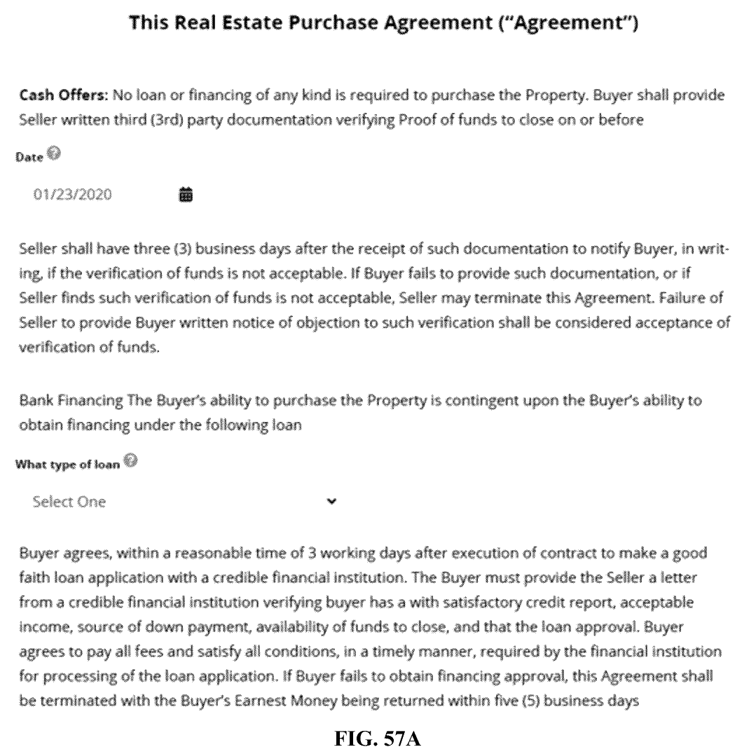

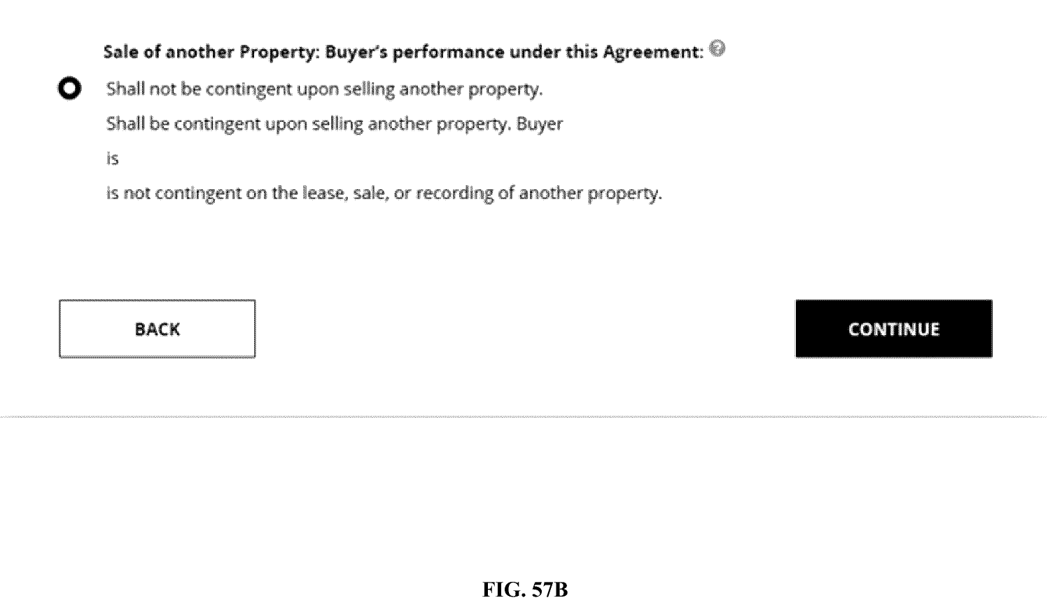

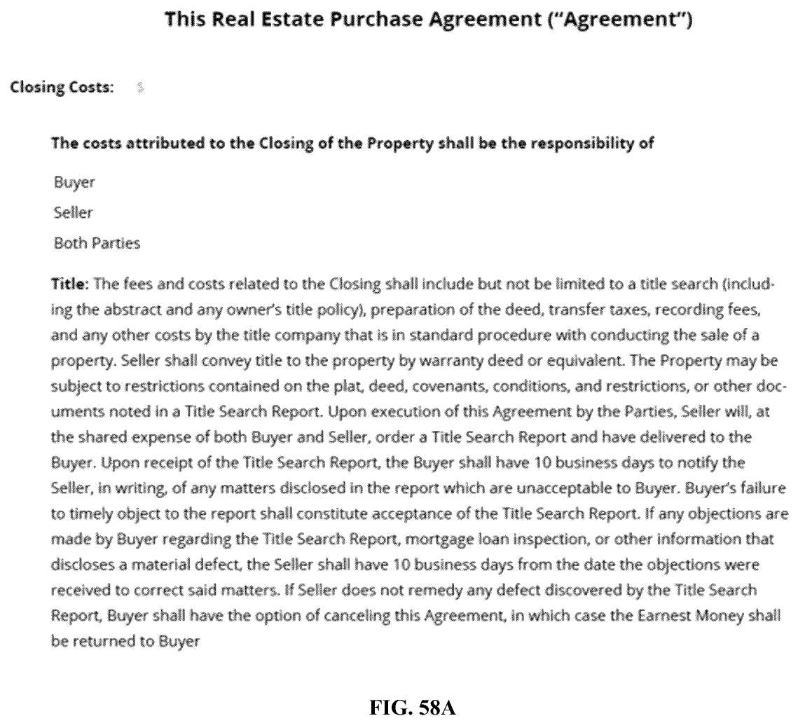

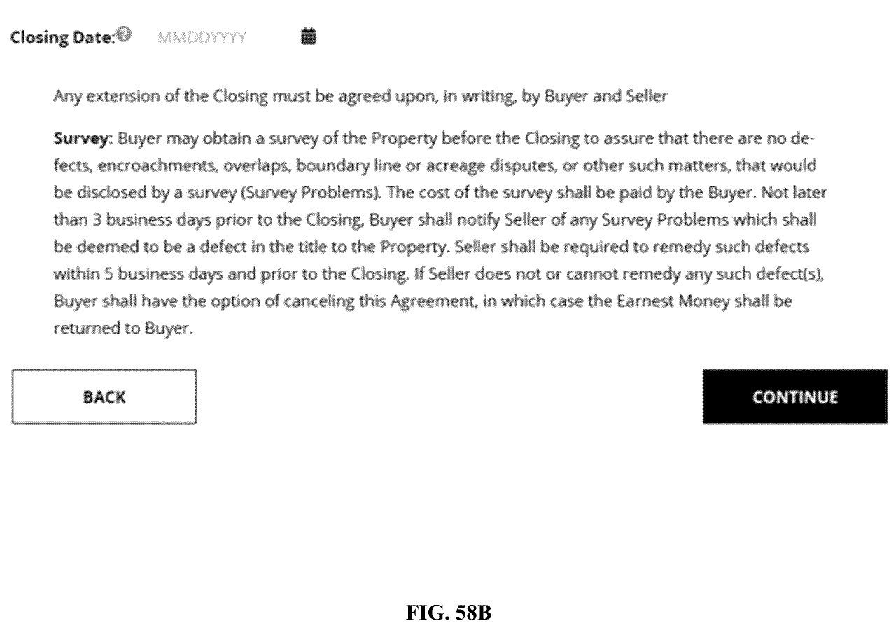

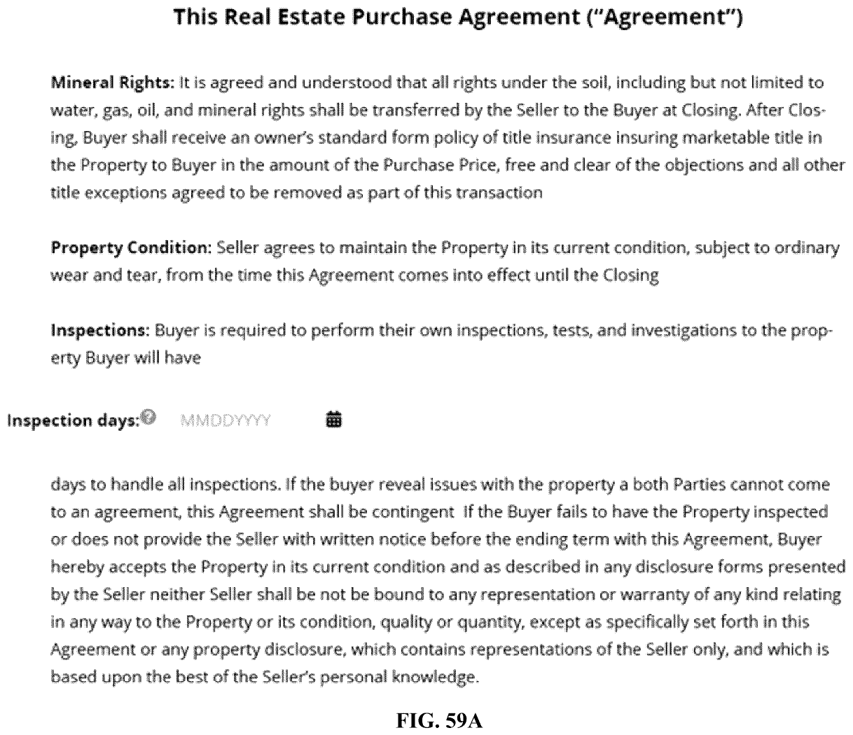

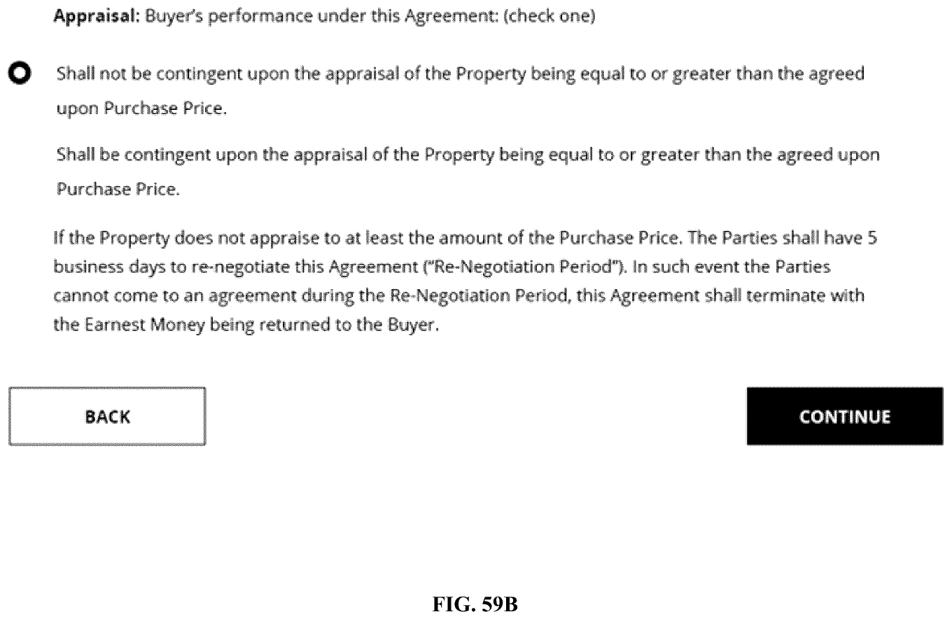

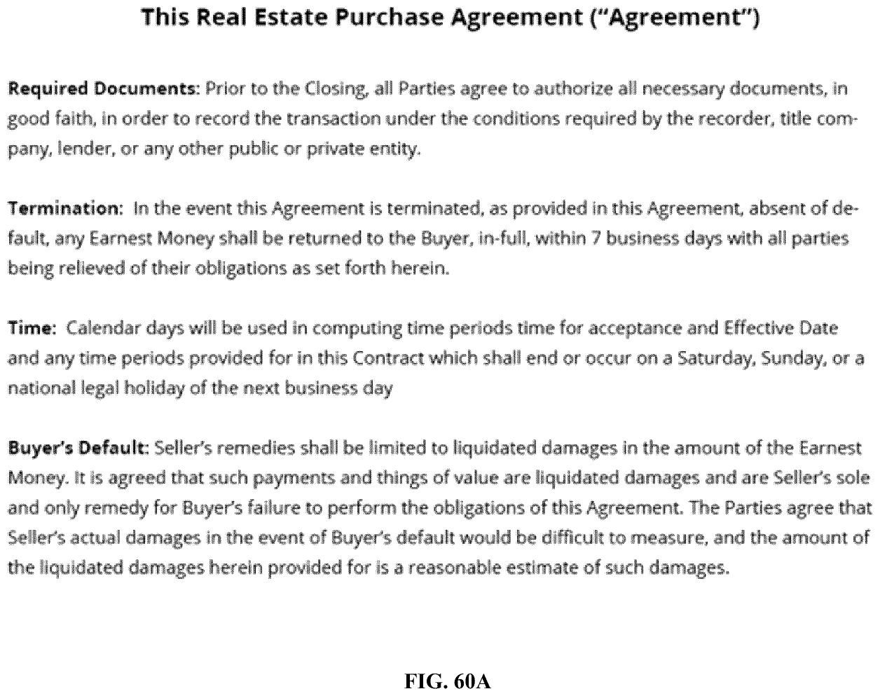

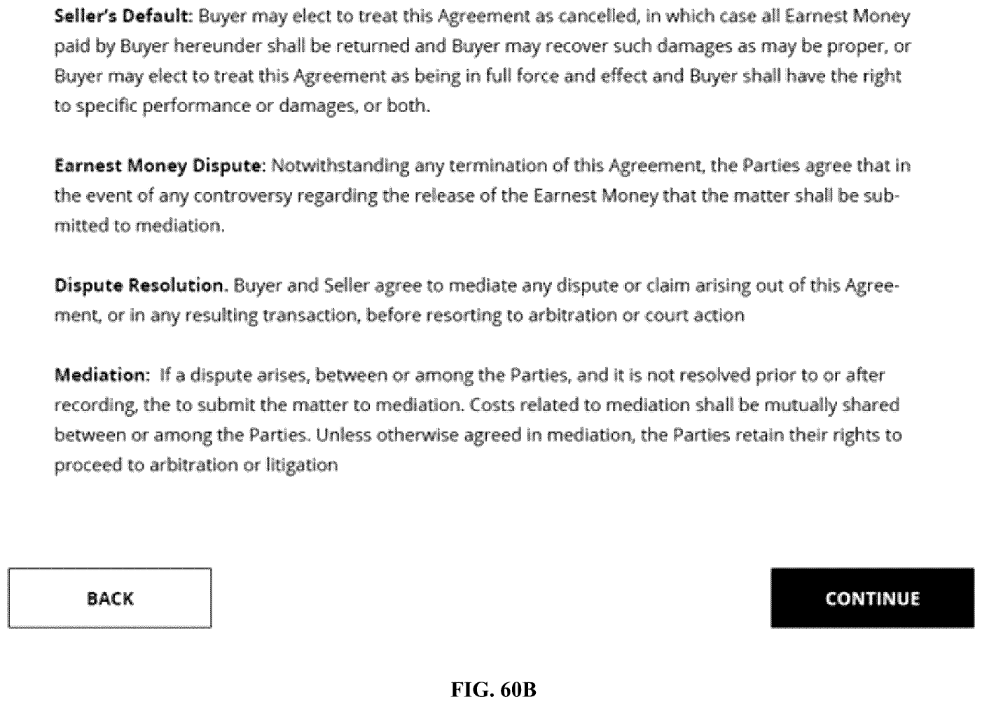

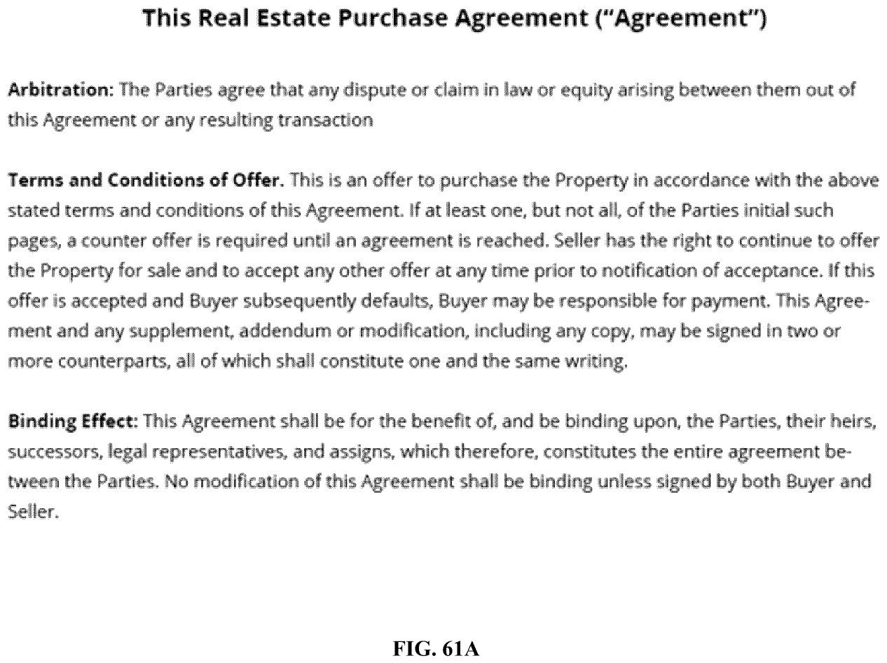

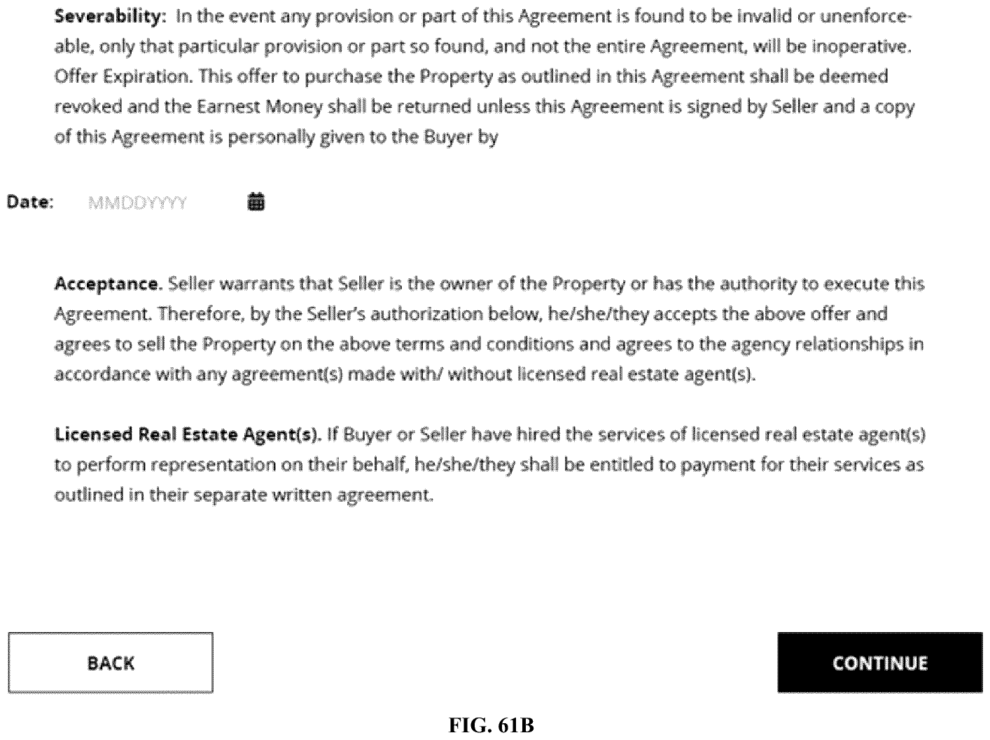

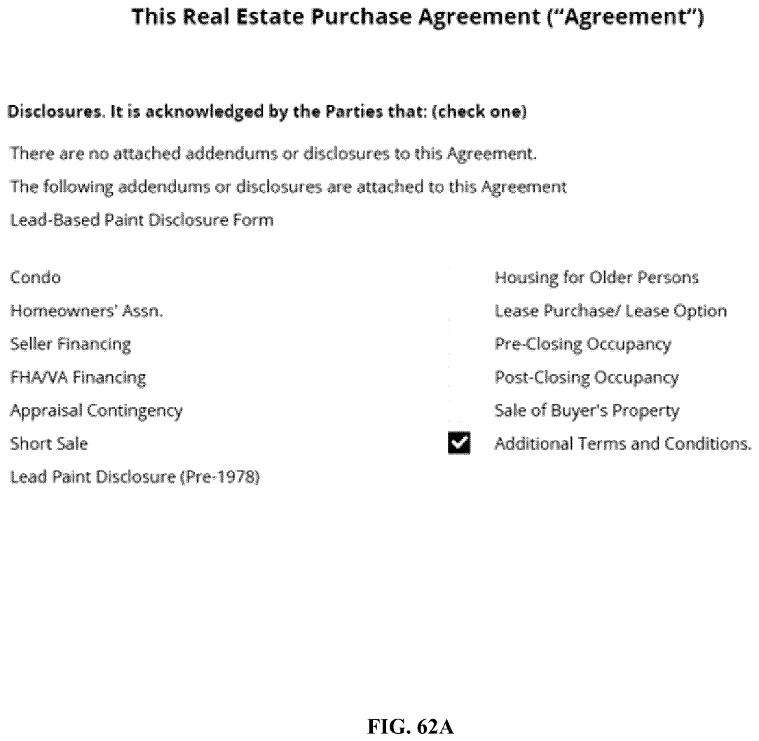

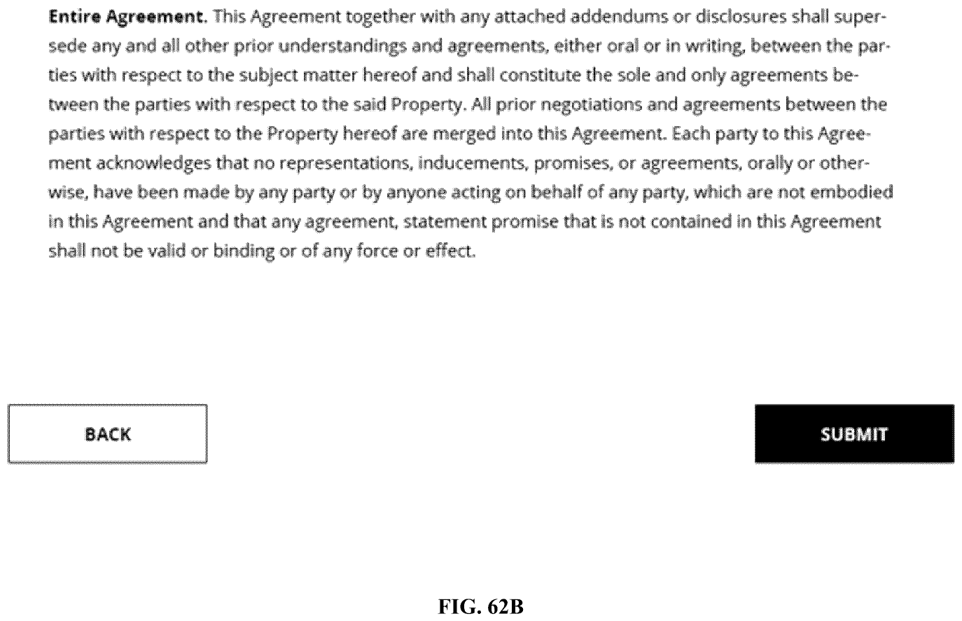

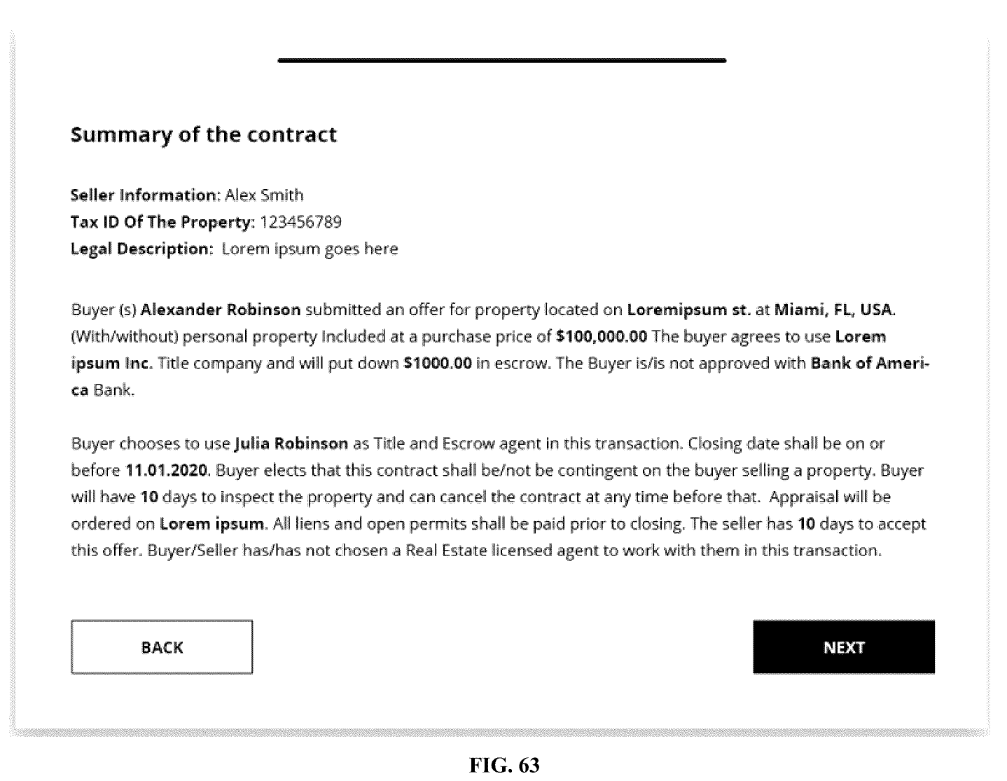

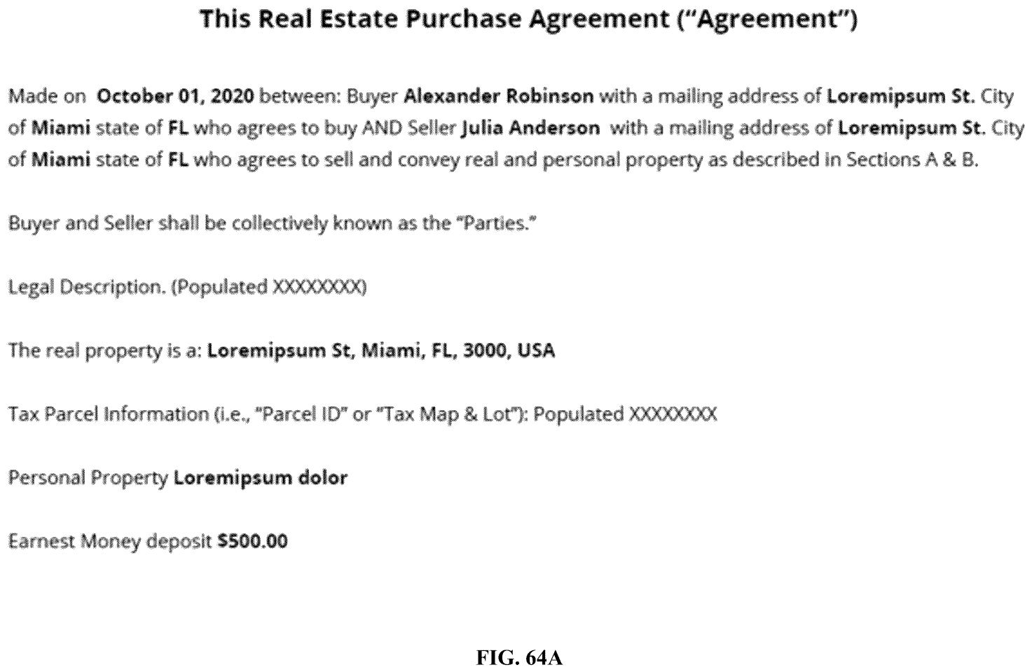

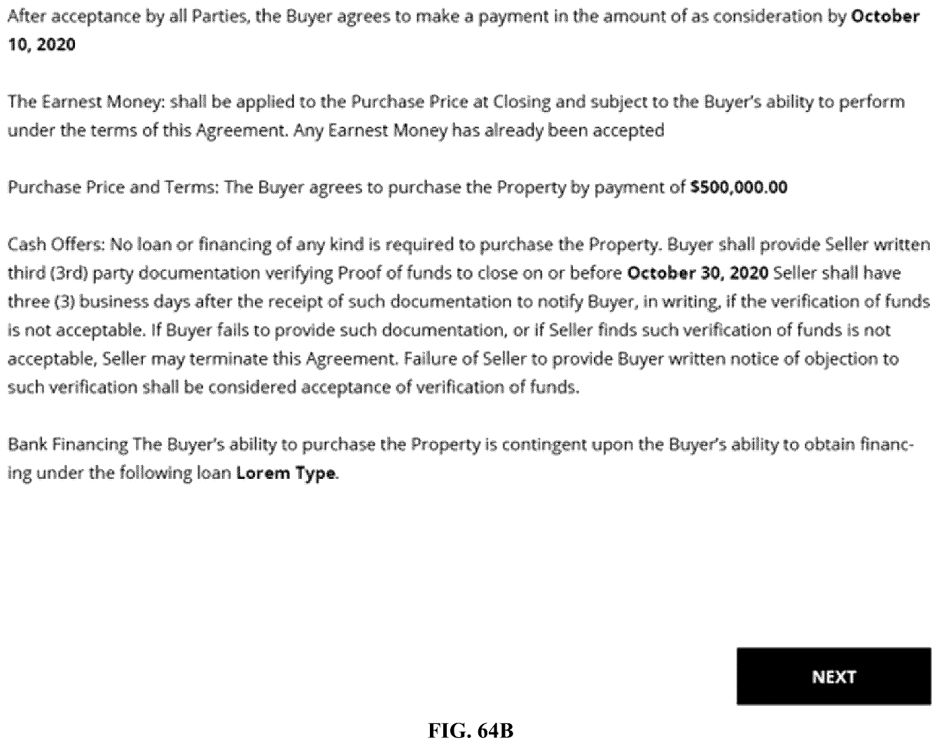

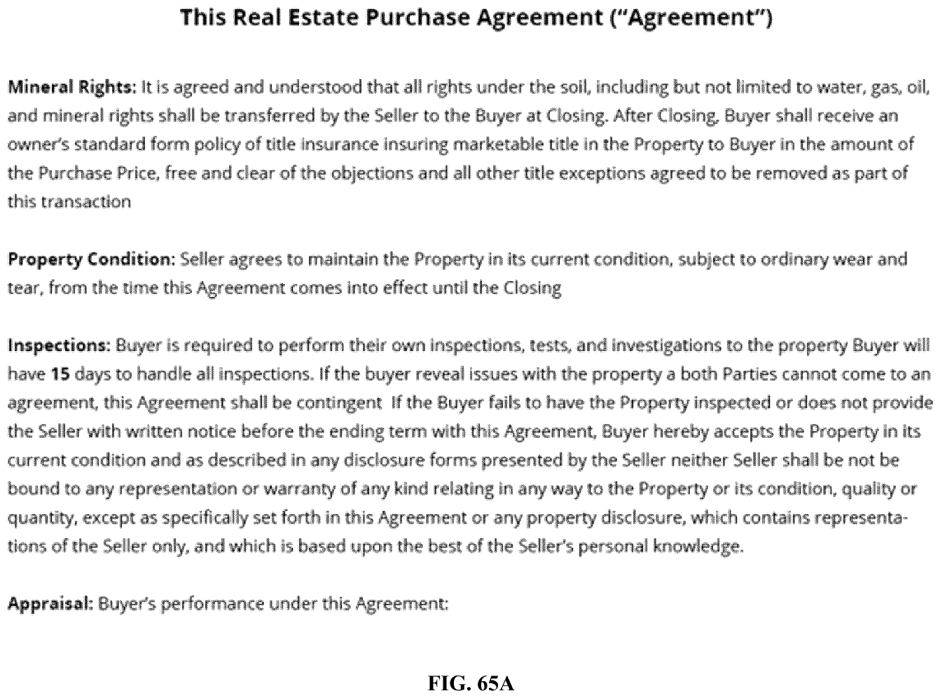

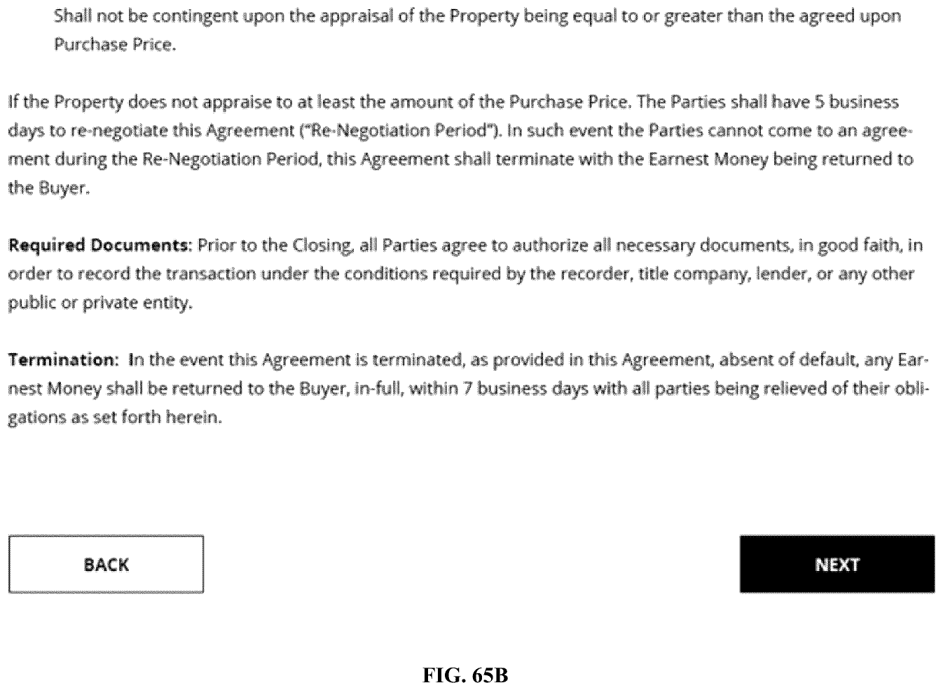

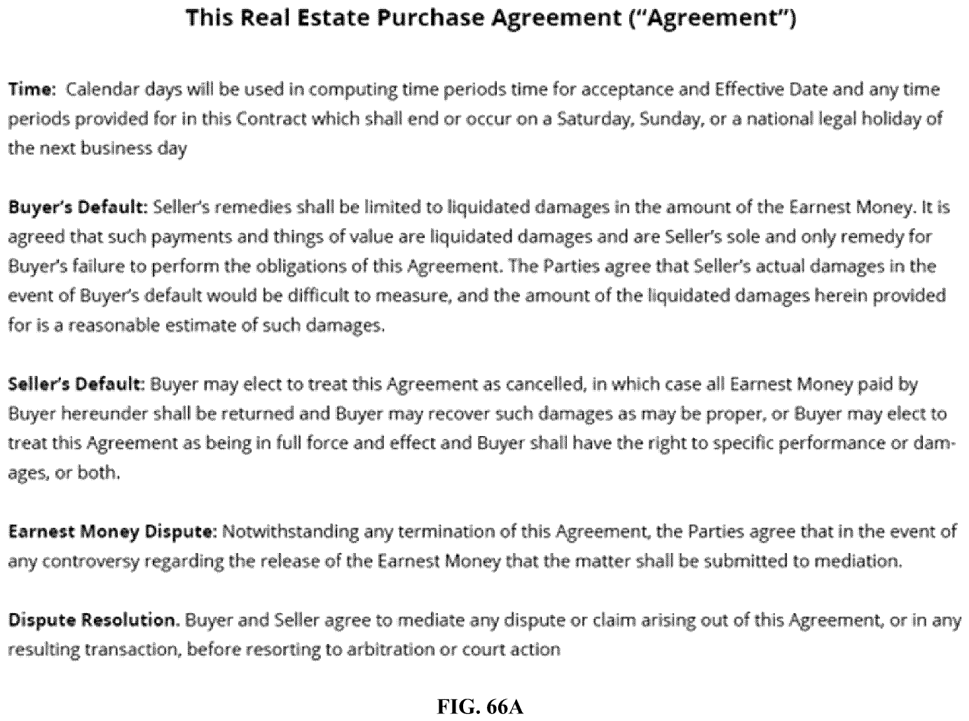

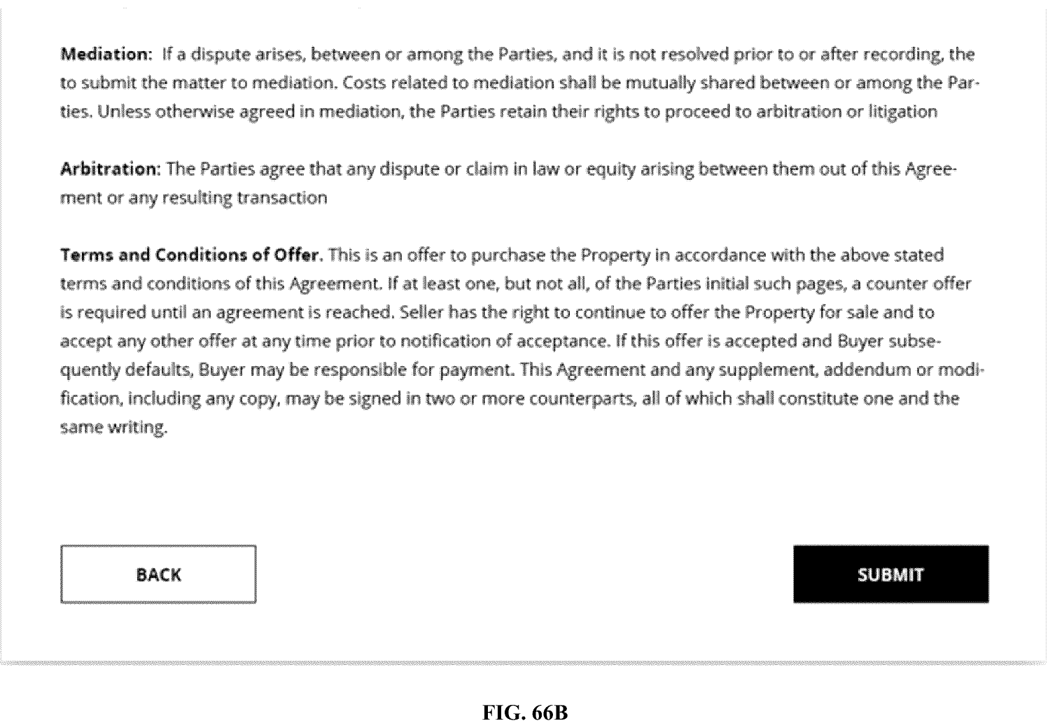

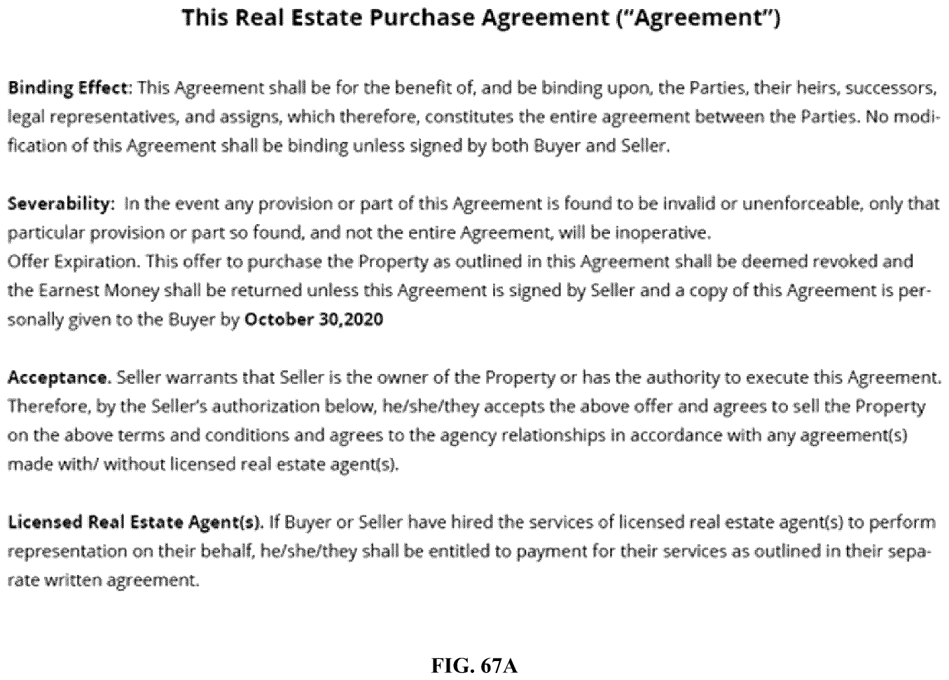

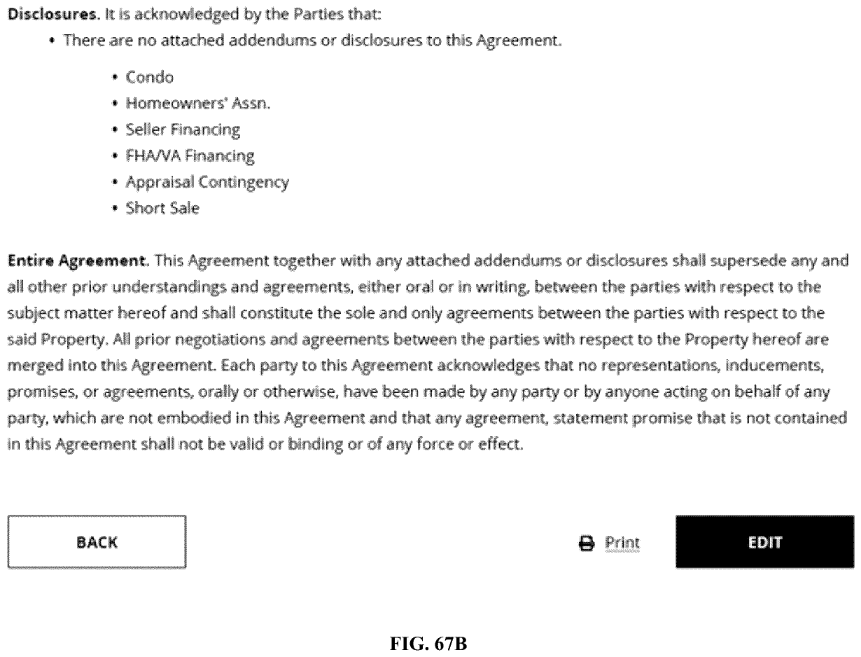

In accordance with a next Step 304, the first user 104a may selectively choose on the first electronic computing device 102a of the first user 104a one of either the “easy” contract formation session or the “do-it-yourself” contract formation session, wherein “easy” is solely used herein for naming purposes and should not be construed otherwise or interpreted in any other matter. As explained above, the “easy” mode poses specific, directed questions to the user 104a, the responses to which are then inserted into the digital real estate contract to form the finalized digital document. This type of contract formation session is preferred for users who are largely unfamiliar with real estate contracts or transactions and are in need of directed and/or assisted guidance with respect to the type of information that must be solicited, gathered, and included in the finalized digital document. FIGS. 11-46 depict the “easy” contract formation session. In contrast, the “do-it-yourself” formation session provides the user 104a with greater flexibility because it grants the user 104a the ability to fill in digital data input fields directly onto the digital document itself until a finalized digital document is achieved. As seen in FIGS. 55-67, the plurality of digital data input fields 1100a-n are contained within the body of the digital document itself. Accordingly, the “do-it-yourself” formation session may be preferable for experts, professionals, or other qualified individuals with experience in the real estate industry.

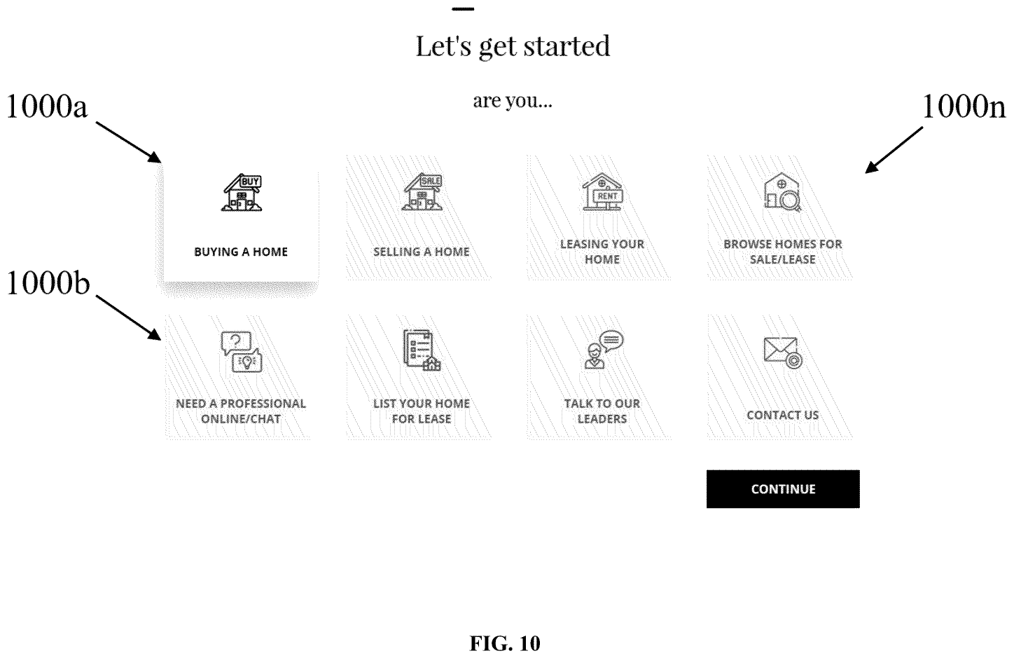

A next Step 305 entails initiating a network-based remote “easy” contract formation session that includes selecting a plurality of GUI icons 1000a-n (as best depicted in FIG. 10) on the electronic display 210 of the first computing device 102a and inputting contract formation data into each of the plurality of digital data input fields 1100a-n. As seen in FIG. 10, the plurality of GUI icons 1000a-n prompt the user 104a to select the type of real estate transaction or contract the user 104a is seeking to prepare or draft. In alternate embodiments, however, the plurality of GUI icons 1000a-n may relate, for example, to a targeted component of the chosen transaction or contract, e.g., type of dwelling, type of financing, etc., and may appear in other steps of the process 300.

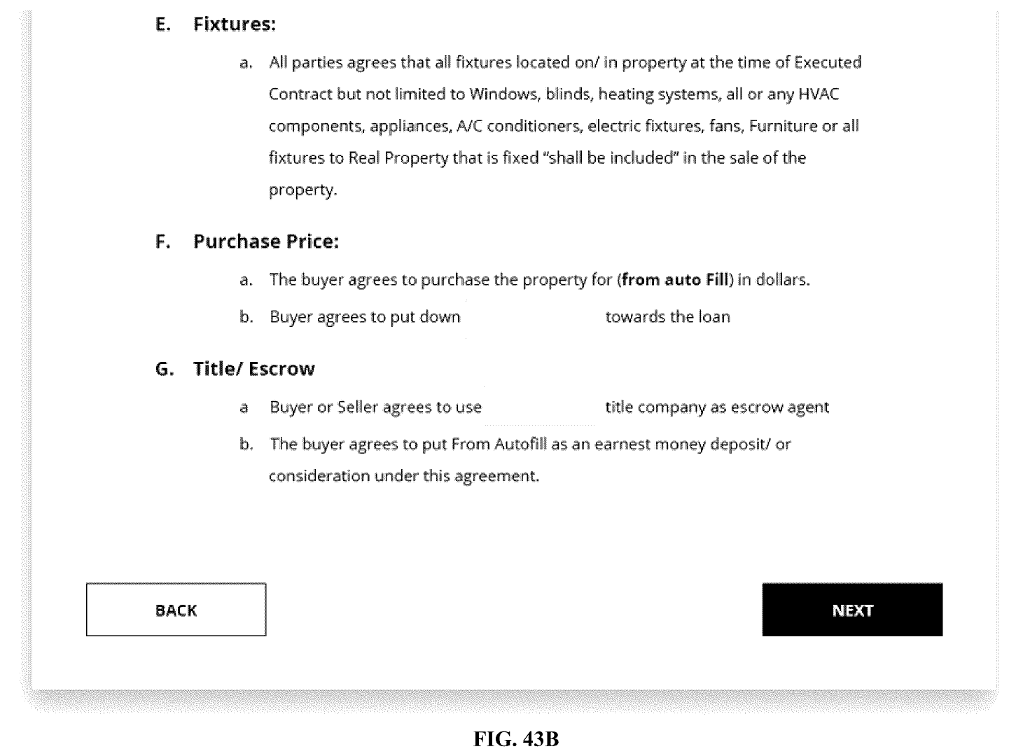

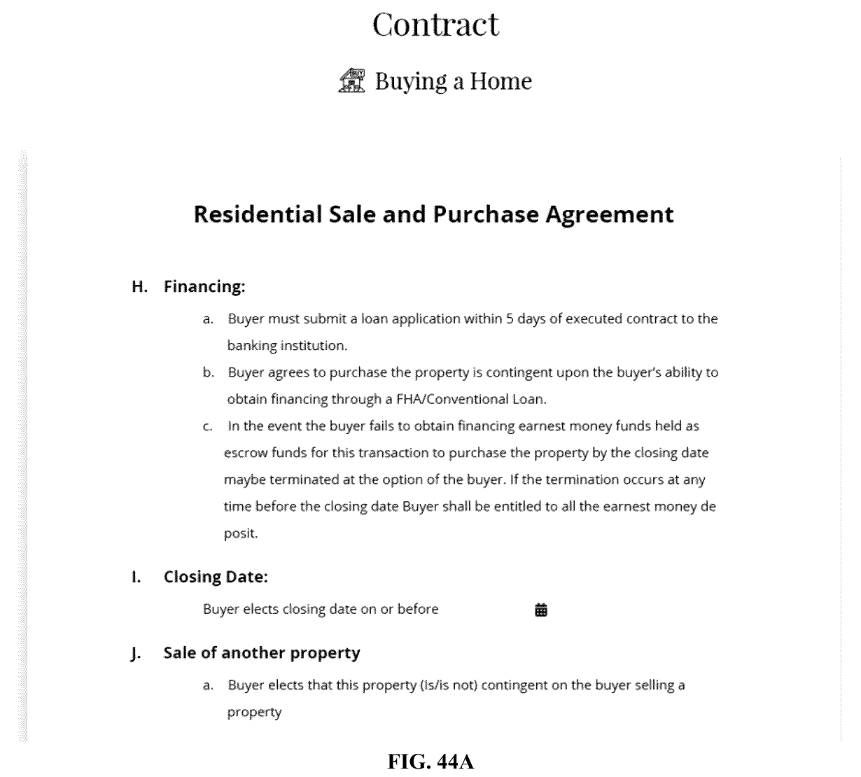

Once the user 104a has selected from the plurality of GUI icons 1000a-n and inputted all contract formation data into each of the plurality of digital data input fields 1100a-n, a final Step 306 includes generating a digital document in the network-based remote “easy” contract formation session with a plurality of independent preformed paragraphs each having at least one fillable contract data field disposed therein and assigned and filled in with, using an array data structure, to one of the plurality of digital data input fields to create a finalized digital document without any fillable contract data field therein and that is downloadable to the electronic display of the first computing device 102a. FIGS. 43-46 depict the finalized digital document that is generated at the conclusion of the “easy” contract formation session. In one embodiment, the finalized digital document is downloadable to the first computing device 102a so as to allow the user 104a the ability to readily save a copy of the finalized digital document for the user's personal records and/or for future use or dissemination. In another embodiment, the finalized digital document may be selectively and readily communicatively sharable with, or transferrable from the electronic display of the first computing device 102a to, a second computing device 102n of a second user 104n over the wireless communication network 106, e.g., the agent of the first user 104a or the other contracting party, to facilitate collaborative efforts and improve the speed and convenience of readily sharing the finalized digital document with other users 104a-n. In accordance with an alternate embodiment of the present invention, the finalized digital document may contain fillable contract data field(s) therein to be completed by another user 104b-n, e.g., the seller's agent, after being communicatively shared with the other user 104b-n over the network 106. In this way, the process 300 can be beneficially collaborative, allowing for multiple users 104a-n to contribute to the finalized digital document that is ultimately created. In the “easy” contract formation session, the one or more fillable contract data field(s) is filled in using an array data structure consisting of a collection of elements (i.e., values or variables), each identified by at least one array index or key. The array is then stored such that the position of each element can be computed from its index tuple by a mathematical formula. The array data structure may be one-dimensional or multidimensional.

In one embodiment, the first electronic computing device 102a of the first user 104a is geographically located at a different physical building location than the computer server 108. This feature beneficially allows the process 300 to be ran at various remote locations by the plurality of users 104a-n. Particularly where the plurality of users 104a-n seek to collaborate on any given real estate contract, this feature facilitates this collaboration as none of the users 104a-n are required to simultaneously be in a shared geographic location with each other or with the server 108 in order to perform the process 300.

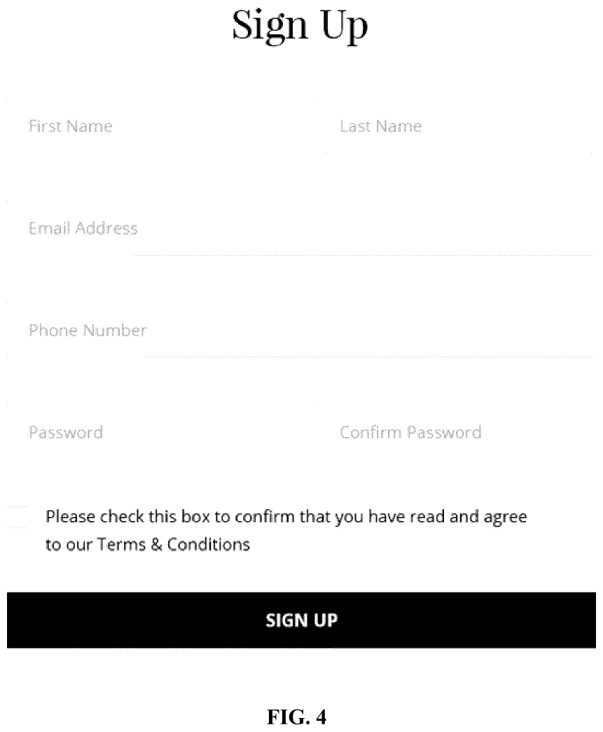

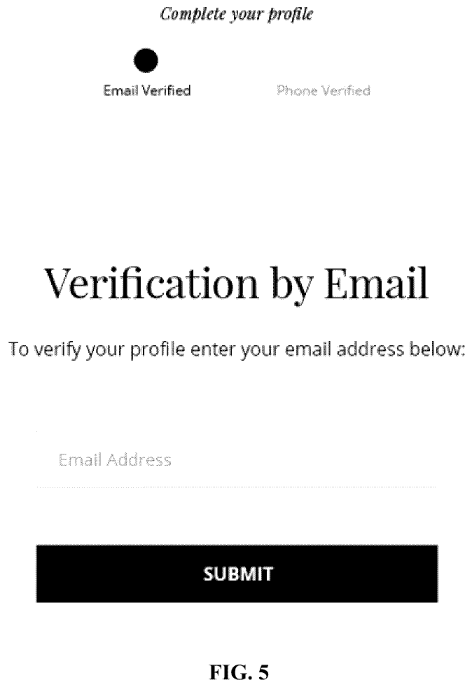

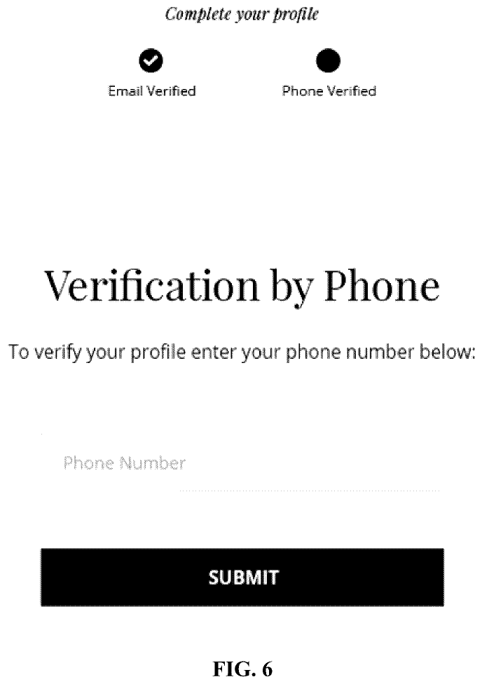

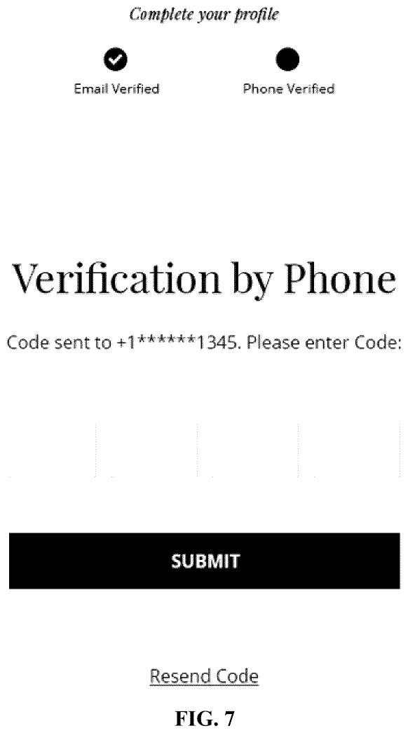

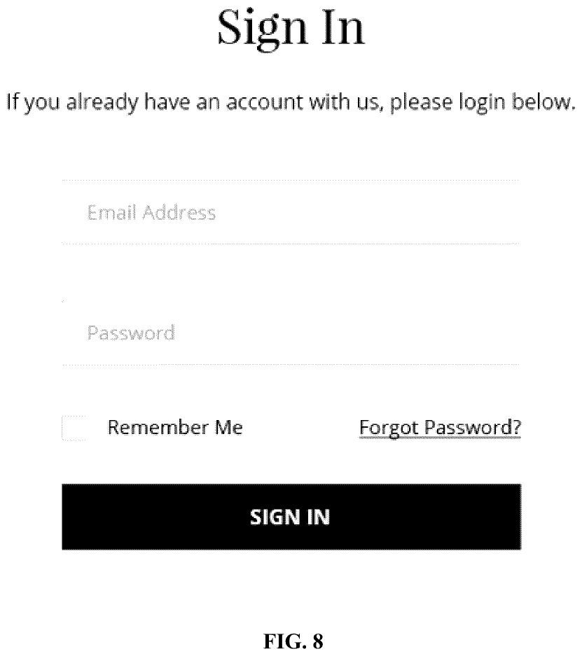

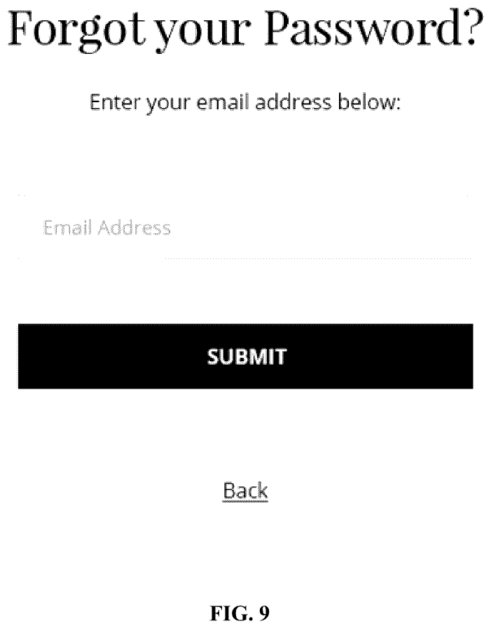

The process 300 may further include the Step of communicatively coupling the first electronic computing device 102a of the first user 104a to the computer server 108 over the wireless communication network 106 and registering into a user account resident on the computer server 108 before generating the digital GUI 202 on the electronic display 210 of the first computing device 102a. Beneficially, this feature allows the user 104a to partially or fully complete a real estate contract through the “easy” contract formation session or the “do-it-yourself” contract formation session and save the user's progress so the user 104a may return to the digital contract at a later time, e.g., to complete, edit, revise, view, or share the digital contract over the network 106 at a later time. Said differently, the user account associated with the user 104a may contain all of the digital contracts prepared and saved by the user 104a. FIGS. 4-9 depict the steps associated with creating and retrieving user accounts. As seen in FIG. 4, the user 104a may be required to input select identifiable personal information, e.g., first and last name, email address, phone number, password, etc., to enable the server 108 to link the user 104a with a specific user account. The process 300 may include additional steps to verify the user account of a user 104a such as, by way of example and without limitation, verifying the email (FIG. 5) or phone number (FIGS. 6-7) of the user 104a by sending a one-time passcode to the user's email or phone number which the user 104a would then need to input to verify their identity and be granted access to the user account. To be granted access to the user account thereafter, the log-in credentials that correspond to the user's user account must be inputted (as depicted in FIG. 8). In the event the user 104a forgets their log-in credentials, there may be a method of retrieving said credentials or verifying the user's identity and resetting the credentials, e.g., by sending a verification code to the email address or phone number originally provided by the user 104a (as seen in FIG. 9).

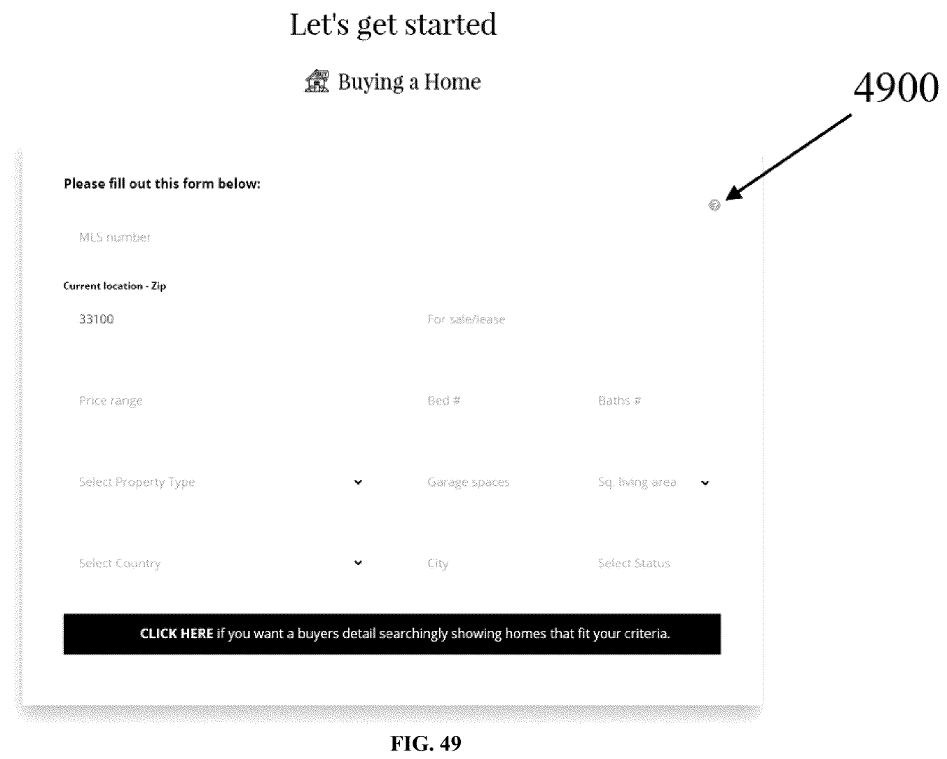

Referring now to FIG. 49, the process 300 may further comprise a digital informational icon 4900 disposed proximal to (wherein “proximal to” is defined herein as at or near) each of the plurality of digital data input fields 1100a-n and having informational text included therein; and displaying the informational text on the electronic display of the first computing device 102a upon selectively modulating the digital informational icon 4900. In an exemplary embodiment, the informational text that accompanies the digital informational icon 4900 offers descriptive, explanatory, and/or guiding text intended to better inform the user 104a of the type of information sought by the digital data input field 1100a associated with that particular digital informational icon 4900. In one embodiment, the informational text visually appears only when the user 104a selectively modulates, e.g., hovers over, selects, or clicks on, the digital informational icon 4900. This feature controls the amount of informational text the user 104a is exposed to at any given time so as to make each Step of the process 300 easier to understand and complete for the user 104a. In other words, this feature beneficially prevents the user 104a from being inundated with superfluous informational text that is pertinent at a later Step in the process 300, e.g., for a subsequent digital data input field 1100b, but that is not directly relevant to the digital data input field 1100a the user 104a is completing at that given moment. Likewise, a plurality of independent and sequentially viewable windows within the network-based remote “do-it-yourself” contract formation session may collectively form part of the digital document with the plurality of GUI icons on the electronic display of the first computing device 102a.

For this same beneficial purpose, namely, to aid the user 104a in understanding, organizing, and completing the process 300, the process 300 may also include a plurality of independent and sequentially viewable windows within the network-based remote “easy” contract formation session that collectively form part of selecting the plurality of GUI icons on the electronic display of the first computing device 102a and the inputting contract formation data into each of the plurality of digital data input fields 1100a-n, the plurality of independent and sequentially viewable windows generating before generation of the digital document in the network-based remote “easy” contract formation session with the plurality of independent preformed paragraphs. In this way, the plurality of digital data input fields 1100a-n are broken up into smaller parts reflected in a plurality of independent and sequentially viewable windows to make the process 300 easier, quicker, and simpler to perform.

In lieu of the network-based remote “easy” contract formation session, the user 104a may initiate the network-based remote “do-it-yourself” contract formation session that includes generating a digital document with a plurality of GUI icons on the electronic display of the first computing device 102a, with a plurality of independent preformed paragraphs each having one or more digital data input field(s) 1100a therein, and filling in the one or more digital data input field(s) 1100a to create a finalized digital document without any fillable contract data field therein and that is downloadable to the electronic display of the first computing device 102a. As such, Step 305 may comprise the foregoing as part of the network-based remote “do-it-yourself” contract formation session as opposed to initiating a network-based remote easy contract formation session that includes selecting a plurality of GUI icons on the electronic display of the first computing device 102a and inputting contract formation data into each of the plurality of digital data input fields as part of the “easy” contract formation session. Based on the needs and preferences of the user 104a, the type of contract formation session, i.e., the “easy” or “do-it-yourself” sessions, may be selectively modified by the user 104a. Said differently, the user 104a may switch from the “easy” contract formation session to the “do-it-yourself” contract formation session, and vice versa, as needed or desired. This feature is particularly beneficial where the needs or expertise of the user 104a vary from real estate transaction to real estate transaction, e.g., the user 104a may be very familiar with the sale of residential dwellings and therefore desire the “do-it-yourself” contract formation session but may be largely inexperienced or unfamiliar with the sale of commercial buildings and therefore stand to benefit more from the “easy” contract formation session in that circumstance.

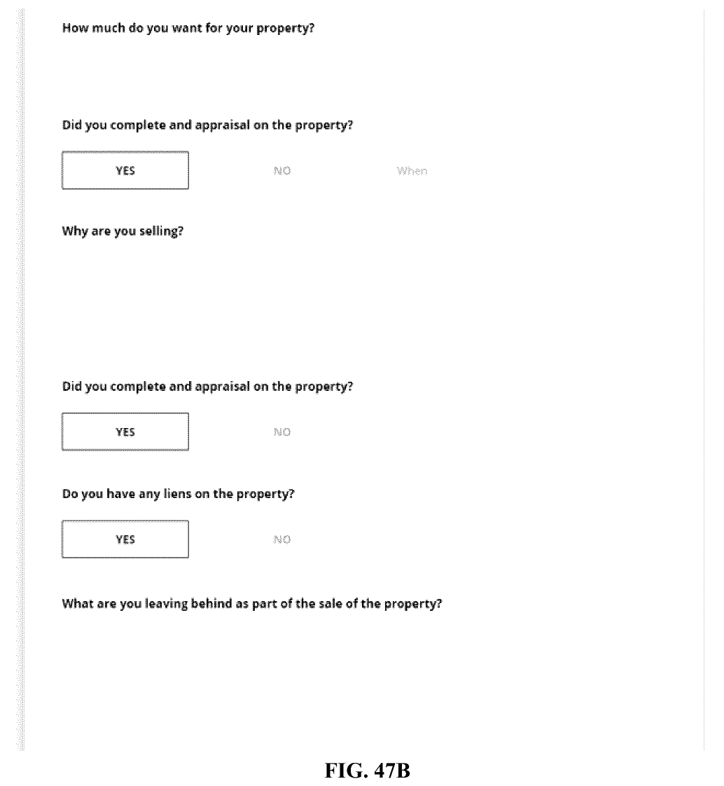

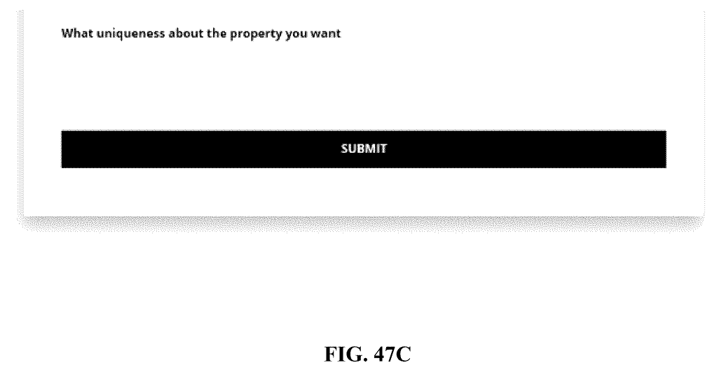

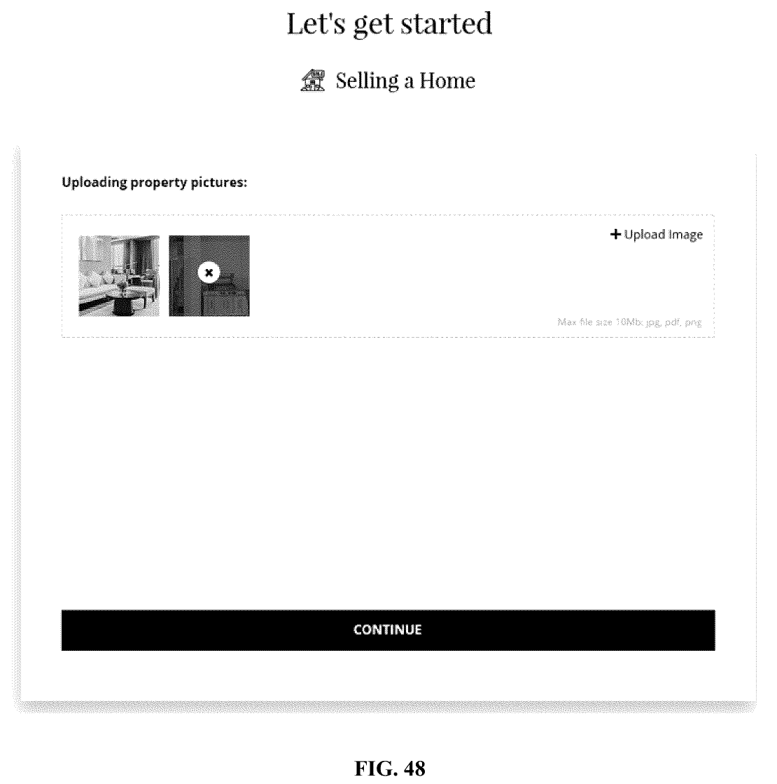

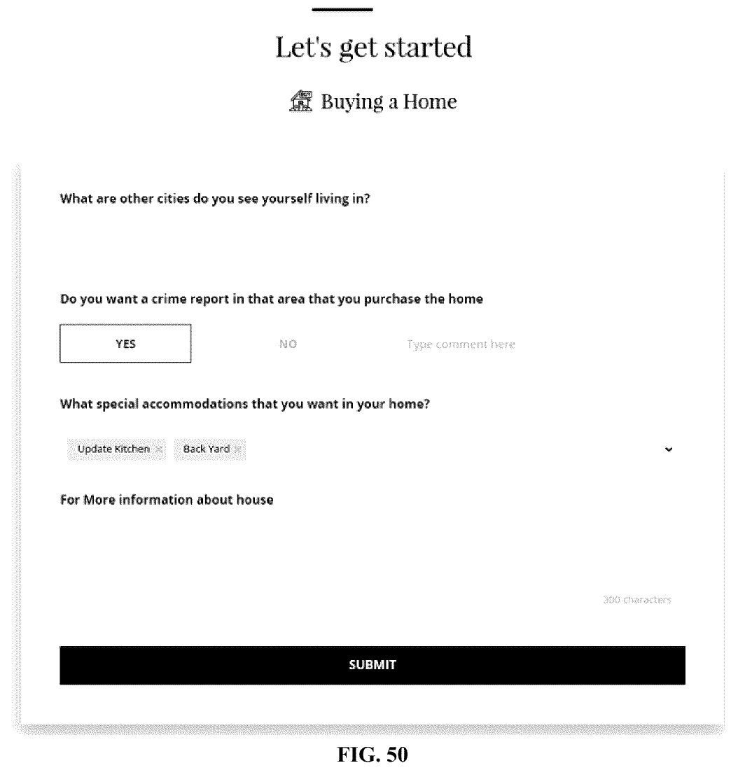

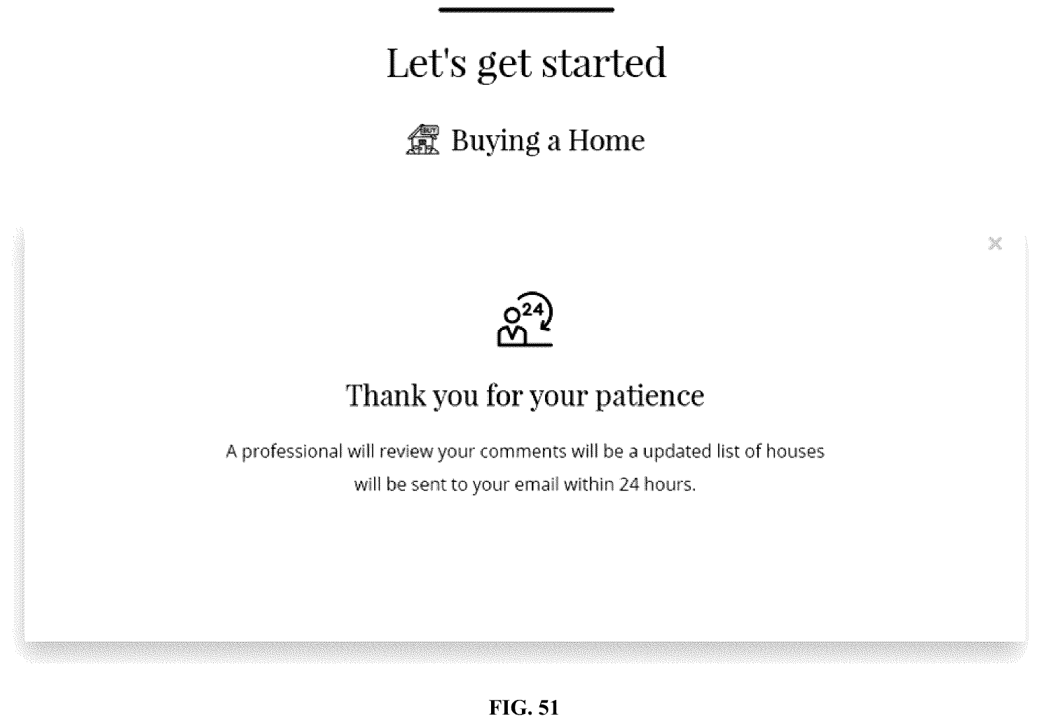

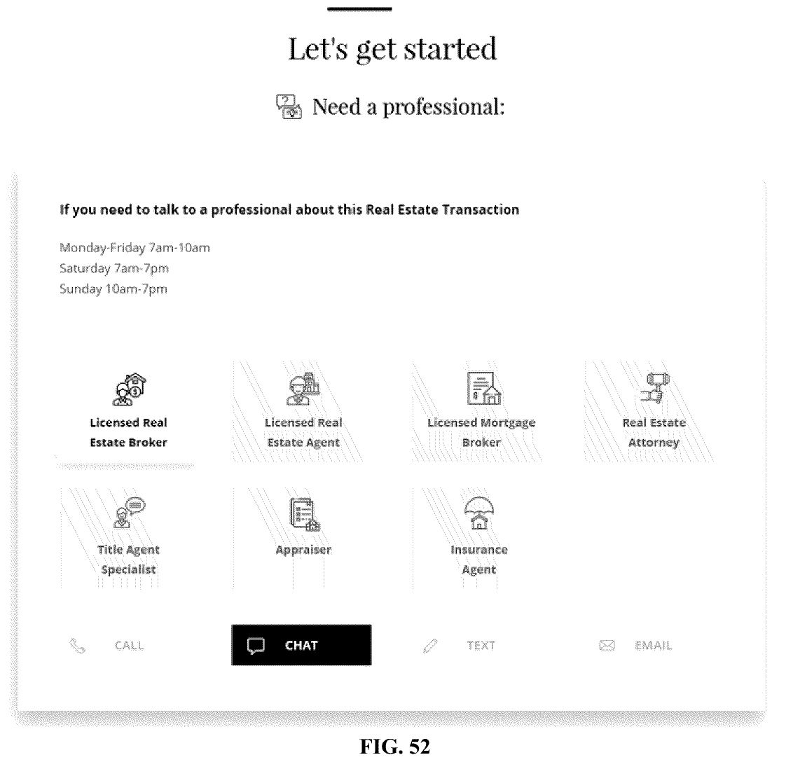

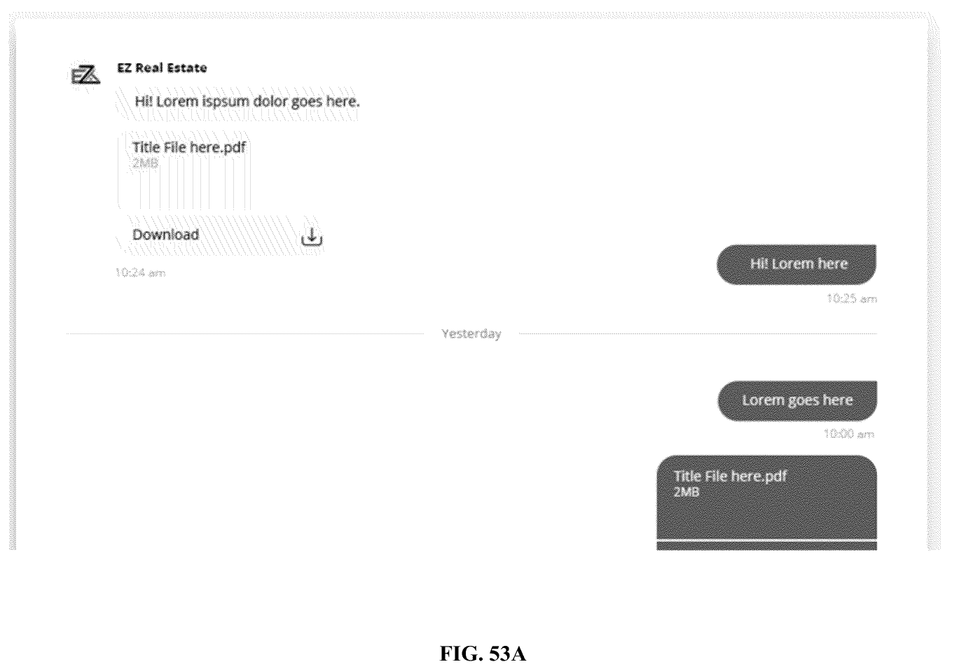

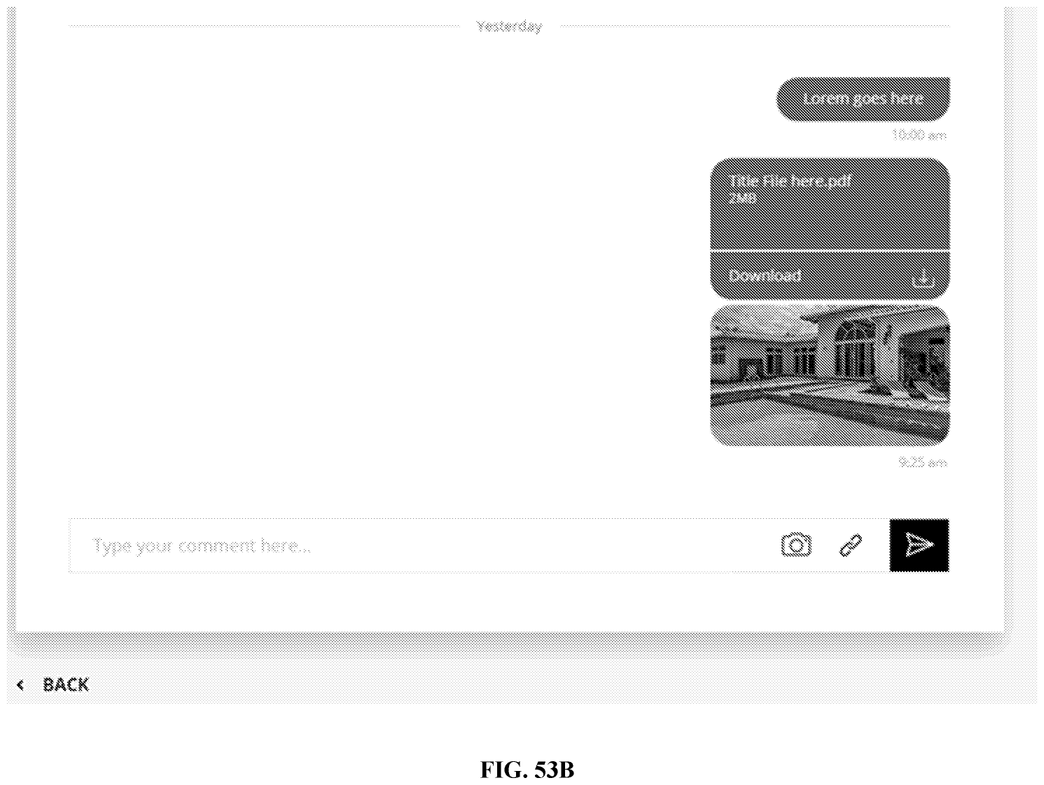

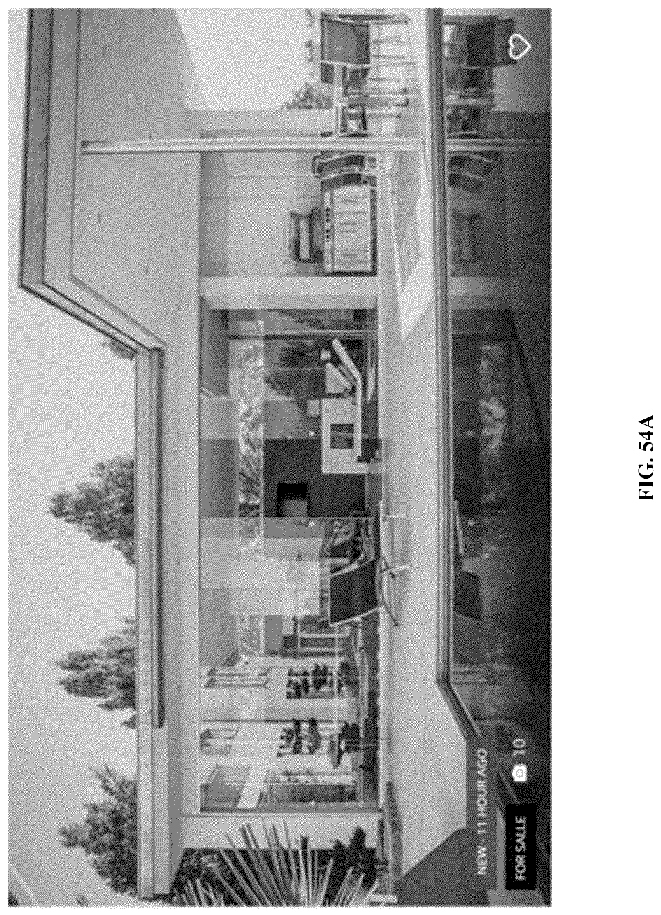

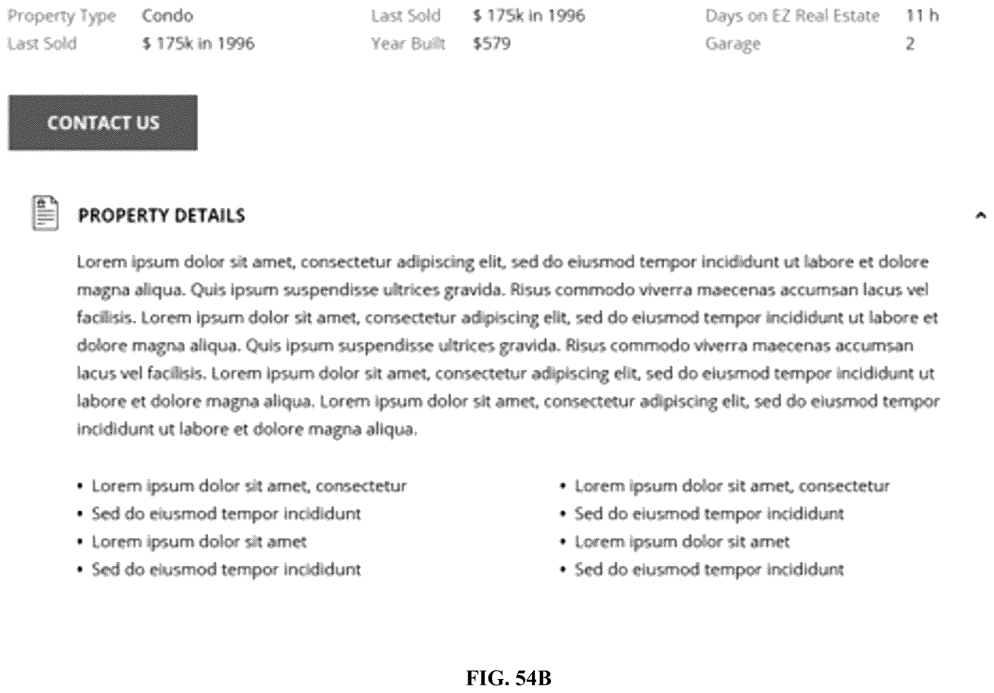

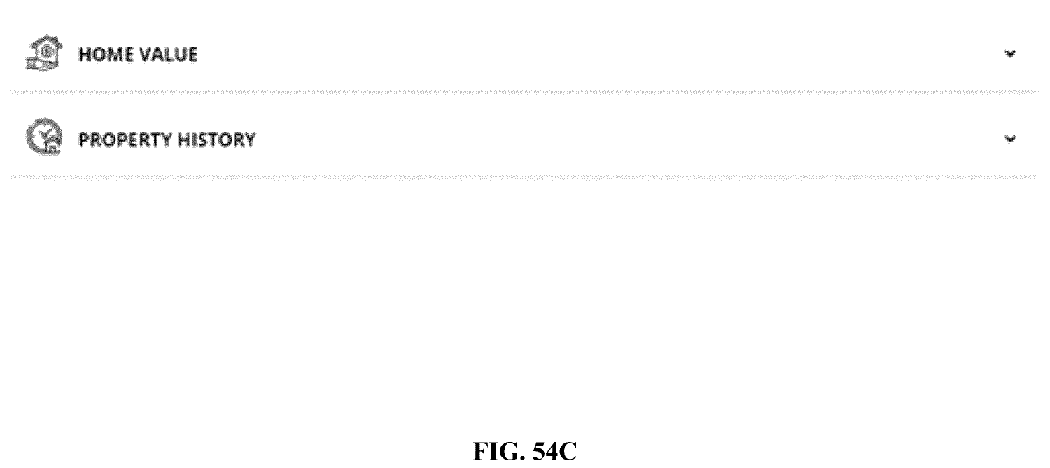

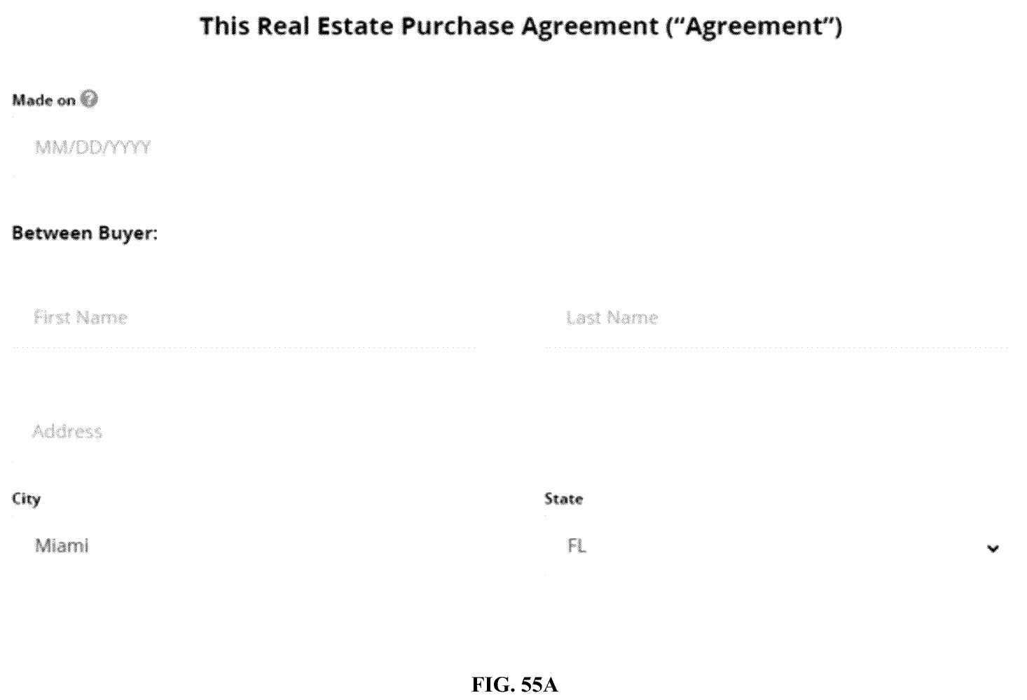

As demonstrated in FIGS. 47-54, the process 300 may also allow the user 104a to perform additional actions associated with or related to real estate, e.g., listing a property for sale (as depicted in FIGS. 47-48), requesting a professional list of properties available for purchase that fit the user's inputted criteria (as seen in FIGS. 49-51), submitting a request for a consultation with a real estate professional such as a licensed real estate broker, a licensed real estate agent, a licensed mortgage broker, a real estate attorney, a title agent specialist, an appraiser, or an insurance agent (as seen in FIG. 52), communicating with a real estate professional over the network 106 (as depicted in FIG. 53), and publishing, browsing, and reviewing property listings (as seen in FIG. 54).

In another embodiment of the present invention, a software-based and coded artificial intelligence (AI) tool is employed that may carry out one or more portions of the computer-implemented and interactive real estate contract generation and editing process. More specifically, the process may be generalized and formed into three steps. The first step, i.e., an “inquisitive analysis” step may include asking pertinent contract formation questions to gather all the necessary information for the contract to be formed or reviewed. The first step may include an AI tool that is operably configured to identify key details (e.g., words, phrases, numbers, and other alpha-numeric text) inserted by the first user or a second user, or simply readable from a contract uploaded by a user, thereby ensuring a comprehensive understanding of the contract requirements. The second step, or an “intelligent summarization” step, may including utilizing an AI tool with an algorithm configured to condense a contract's written content or a user's inputted contract formation data into a concise and easily digestible format, e.g., through displaying said contract's written content as part of the one or more contract formation text within the plurality of independent and sequentially viewable windows. This second step enables swift comprehension and saves valuable time for all parties/user involved. The third step, i.e., “streamlined contract formulation” step, may include generating or formulating a legal contract by utilizing the pertinent extracted information and summarized content. As such, the contract formation process has been automated with AI, eliminates human error, and expedites the creation of accurate and legally sound agreements. Stated even further, the process integrates the AI tool into the contract management process to navigate the complexities rear estate contracts and other contractual agreements with utmost efficiency and precision. The summarization process referenced above is also operable to connect sentences from the data entered in the inquiry phase and can be interrupted in the language of the user to understand the meaning of summarization. Once a user receives a contract, the system and process are also configured to promptly acknowledge its arrival and then may proceed to simplify the contract using everyday common language, making it easier for the user to understand. Additionally, the system allows the user to input any counter terms they may have.

The process may begin and immediately proceed to the step of providing a first electronic computing device of a first user and having an electronic display configured to display a digital graphical user interface (GUI) and a computer server (as exemplified in FIG. 1). Next, the process includes communicatively coupling the first electronic computing device of the first user to the computer server over a wireless communication network (also exemplified in FIG. 1). Next, the process may include initiating a network-based remote easy contract formation session having multiple ancillary steps (that may be executed locally on the first user's 104a electronic device 102a).

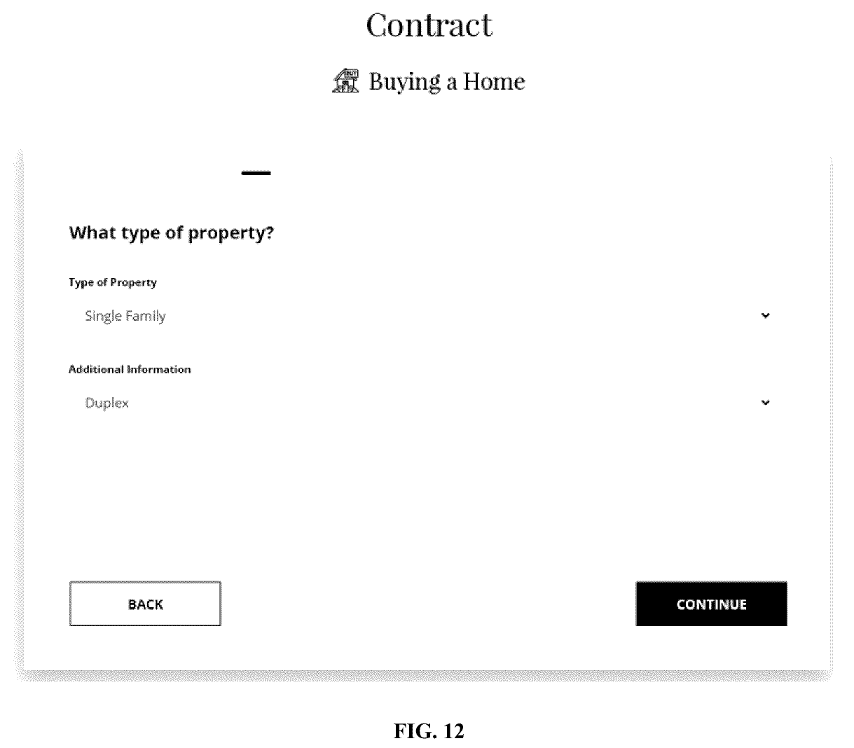

One such ancillary step includes generating a plurality of independent and sequentially viewable windows on the GUI of the electronic display of the first electronic computing device, wherein each of the independent and sequentially viewable windows display one or more contract formation text therein (e.g., “what type of property” is being bought—see, e.g., FIG. 12) and at least one digital data input field (see, e.g., FIG. 12). Another exemplary ancillary step includes receiving alpha-numeric text corresponding to contract formation data within each of the plurality of digital data input fields from the first user (see, e.g., FIG. 12).

Beneficially, another exemplary ancillary step includes executing a software-based learning tool (locally on the first user's device 102a or on the server 108) that is programmed to ascertain and ascertains the contract formation data, in addition to comparing said contract formation data to a learning data structure to ascertain a match corresponding to a user understanding of the at least one contract formation text associated with each of the independent and sequentially viewable windows. Said another way, the software-based learning tool may ascertain and review input in response to the “type of property” that is being bought and if the user inserts $200,000, the software-based learning tool is require the first user to re-insert new contract formation data and/or rephrase and/or re-display the at least one contract formation text to ensure the first user (or other users, if applicable) understands the inquiry. The software-based learning tool is capable of learning in that it may autonomously update the learning data structure with the user inputted “non-matched” text if inserted in a predetermined and programed number of different network-based remote easy contract formation sessions, agreed to be two or more different users, etc. A “match” may include, but not necessarily limited to, the identical wording of the contract formation data when compared to the programmed in the learning data structure (which may be stored resident on the server 108 for speed and efficiency in the formation process).

Thereafter, another exemplary ancillary step may include generating, after completion of the plurality of independent and sequentially viewable windows and at a conclusion of the network-based remote easy contract formation session, a digital document with a plurality of independent paragraphs each having at least one fillable contract data field disposed therein and assigned to and filled in with at a portion of software-defined and software-selected contract formation data using the software-based learning tool to create a finalized digital document without any fillable contract data field therein. Said differently, the software-based learning tool is programmed select all or a portion of the contract formation data such that it makes sense (based on a programmed or learned data structure) of the contract formation data within the overall and surrounding text of the written contract. To that end, the AI tool may be programmed to rewrite sentences, portions of sentences, words, or paragraphs of the digital document to ensure clarity of the contract. Stated further, the software-based learning tool may be, as described above, programmed to ascertain and ascertains the contract formation data and compares said contract formation data to a learning data structure to ascertain a match or a close-match (having common misspellings of certain words commonly used in response to an inquiry).

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the above described features.

What is claimed is:

1. A computer-implemented and interactive real estate contract generation and editing process comprising the steps of:
providing a first electronic computing device of a first user and having an electronic display configured to display a digital graphical user interface (GUI) and a computer server;
communicatively coupling the first electronic computing device of the first user to the computer server over a wireless communication network; and
initiating a network-based remote easy contract formation session that includes:
generating a plurality of independent and sequentially viewable windows on the GUI of the electronic display of the first electronic computing device, wherein each of the independent and sequentially viewable windows displaying at least one contract formation text therein and at least one digital data input field;
receiving alpha-numeric text corresponding to contract formation data within each of the plurality of digital data input fields from the first user;
executing a software-based learning tool ascertaining the contract formation data and comparing it to a learning data structure to ascertain a match corresponding to a user understanding of the at least one contract formation text associated with each of the independent and sequentially viewable windows; and
generating, after completion of the plurality of independent and sequentially viewable windows and at a conclusion of the network-based remote easy contract formation session, a digital document with a plurality of independent paragraphs each having at least one fillable contract data field disposed therein and assigned to and filled in with at a portion of software-defined and software-selected contract formation data using the software-based learning tool to create a finalized digital document without any fillable contract data field therein.

2. The computer-implemented process according to claim 1, wherein the plurality of digital data input fields are each identified by an assigned array index on an array data structure.

3. The computer-implemented process according to claim 1, wherein the plurality of digital data input fields each have a GUI informational icon disposed proximal to each of the plurality of digital data input fields, the GUI informational icon having informational text included therein and displaying the informational text on the electronic display of the first computing device upon selectively modulating the GUI informational icon.

4. The computer-implemented process according to claim 1, wherein the network-based remote easy contract formation session further comprises:
generating a plurality of GUI icons each corresponding to a type of real estate transaction the first user is seeking to prepare.

5. The computer-implemented process according to claim 1, wherein:
the first electronic computing device of the first user is geographically located at a different physical building location than the computer server.

6. The computer-implemented process according to claim 1, further comprising:
registering the first user by associating the first user to a user account resident on the computer server before generating the independent and sequentially viewable windows.

7. The computer-implemented process according to claim 1, further comprising:
generating the finalized digital document without fillable contract data field therein and that is transferrable from the electronic display of the first computing device to a second computing device of a second user over the wireless communication network.

8. A computer-implemented and interactive real estate contract generation and editing process comprising the steps of:
providing a first electronic computing device of a first user and having an electronic display configured to display a digital graphical user interface (GUI) and a computer server;
communicatively coupling the first electronic computing device of the first user to the computer server over a wireless communication network; and
initiating a network-based remote easy contract formation session that includes:
generating a plurality of independent and sequentially viewable windows on the GUI of the electronic display of the first electronic computing device, wherein each of the independent and sequentially viewable windows displaying at least one contract formation text therein and at least one digital data input field identified by an assigned array index on an array data structure;
receiving alpha-numeric text corresponding to contract formation data within each of the plurality of digital data input fields from the first user; and
generating, after completion of the plurality of independent and sequentially viewable windows and at a conclusion of the network-based remote easy contract formation session, a digital document with a plurality of independent preformed paragraphs each having at least one fillable contract data field disposed therein and assigned to, using the array data structure with the assigned array index, and filled in with contract formation data received within each of the plurality of digital data input fields from the first user to create a finalized digital document without any fillable contract data field therein.

9. The computer-implemented process according to claim 8, wherein the plurality of digital data input fields each have a GUI informational icon disposed proximal to each of the plurality of digital data input fields, the GUI informational icon having informational text included therein and displaying the informational text on the electronic display of the first computing device upon selectively modulating the GUI informational icon.

10. The computer-implemented process according to claim 8, wherein the finalized digital document without any fillable contract data field therein is downloadable to the electronic display of the first computing device.
